(19) United States
(12) Patent Application Publication
(10) Pub. No.: US 2014/0172678 A1
(43) Pub. Date: Jun. 19, 2014

(54) INSTITUTION SIMULATION

(71) Applicants: Craig Alan Stephens, Unteraegeri (CH); Johannes Andreas Harbig, Unteraegeri (CH); Alan Karl Graham, Lexington, MA (US); Mariano Blanc, Asturias (ES); David W. Peterson, Harvard, MA (US)

(72) Inventors: Craig Alan Stephens, Unteraegeri (CH); Johannes Andreas Harbig, Unteraegeri (CH); Alan Karl Graham, Lexington, MA (US); Mariano Blanc, Asturias (ES); David W. Peterson, Harvard, MA (US)

(21) Appl. No.: 13/715,308

(22) Filed: Dec. 14, 2012

(51) Int. Cl. G06Q 10/06

(52) U.S. Cl. CPC G06Q 10/0637
USPC 705/38; 705/301

(57) ABSTRACT

Among other things, a calibrated and tested dynamic simulation model of at least one municipality or institution or commercial entity is operated to generate information that enables the municipality or institution or commercial entity and suppliers of products for development projects of the municipality or institution or commercial entity to engage in execution of development projects that the model demonstrates will enhance the performance and sustainability of the municipality or institution or commercial entity. The simulation model of the municipality or institution or commercial entity is used to monitor and influence the execution of the development projects or ongoing operations and policies of the municipality or institution or commercial entity. Financers of the development projects are provided with information from operation of the dynamic simulation model that demonstrates the performance and sustainability of the municipality or institution or commercial entity and the acceptability of risks associated with the financing of the projects or operations.

### BACKGROUND

This description relates to dynamic simulation of institutions, such as municipalities and corporations.

Many institutions struggle to sustain their performance and even their existence in the face of changing internal or external conditions. For instance, mature cities may decline and fast-growing cities may struggle to cope with in-migration or pollution. National, regional, or local governments may carry large fiscal deficits or growing debt. Employers, pension funds, and insurance companies often have rapidly growing and partially or completely unfunded liabilities.

### SUMMARY

In general, in an aspect, a calibrated and tested dynamic simulation model of at least one municipality or institution or commercial entity is operated to generate information that enables the municipality or institution or commercial entity and suppliers of products for development projects of the municipality or institution or commercial entity to engage in execution of development projects that the model demonstrates will enhance the performance and sustainability of the municipality or institution or commercial entity. The municipality or institution or commercial entity may include subsidiary municipalities, institutions, or commercial entities. The simulation model of the municipality or institution or commercial entity is used to monitor and influence the execution of the development projects or ongoing operations and policies of the municipality or institution or commercial entity. Financers of the development projects are provided with information from operation of the dynamic simulation model that demonstrates the performance and sustainability of the municipality or institution or commercial entity and the acceptability of risks associated with the financing of the projects or operations. The municipality or institution or commercial entity employs the simulation model to monitor and influence its development projects and ongoing operations and policies and performance and how they affect returns on and the return of finance capital, so as to ensure the sustainability of financing.

Implementations may include one or more of the following features. There may be one or more than one simulation model of the municipality or institution or commercial entity. The simulation model or models span two or more development projects of the municipality or institution or commercial entity as well as its policies and ongoing operations. The one or more development projects may include projects to develop infrastructure, products, services, technologies, methods, resources, processes, or other items or assets. The two or more development projects may be synergistic relative to the performance and sustainability of the municipality or institution or commercial entity. The dynamic simulation model or models have been tested, calibrated, and validated using historical data representing operations and policies of the municipality or institution or commercial entity. The products, infrastructure, equipment, or services provided by or suppliers may have characteristics that are particularly applicable to the development projects or the operations of the municipality or institution or commercial entity based on the information generated by the simulation model or models. The municipality or institution or commercial entity and the suppliers may both have access to operation or results of the dynamic simulation model. The other stakeholders of the municipality or institution or commercial entity may have access to operation or results of the dynamic simulation model. The financers may have access to operation or results of the dynamic simulation model. The information is provided to the financers of the development projects prior to their financing the projects. The information is provided to the financers of the development projects after they have financed the projects, during the period when the projects are being executed and operated. The financers may interact with the municipality or institution or commercial entity in evaluating and influencing the sustainability of the financing. The municipality or institution or commercial entity includes a city. The municipality or institution or commercial entity includes contiguous cities and towns. The suppliers include suppliers of physical facilities or equipment or services. The development projects include infrastructure projects. The dynamic simulation model may be operated by the municipality or institution or commercial entity or by some agent set up or appointed by the municipality or institution or commercial entity for that purpose or by one or more of the suppliers or by one of more of the financers or by one or more parties other than. The dynamic simulation model is operated by at least one of the suppliers. The dynamic simulation model is operated by at least one of the financers. The dynamic simulation model is operated by a party other than the municipality or institution or commercial entity, the suppliers, or the financers.

In general, in an aspect, a supplier of products for development projects or operations and policies of a municipality or institution or commercial entity can access a calibrated and tested dynamic simulation model of the municipality or institution or commercial entity. The supplier of products, infrastructure, equipment, or services can design products for the development projects that will enhance the performance and sustainability of the municipality or institution or commercial entity based on the dynamic simulation model. The supplier of products can also provide to the municipality or institution or commercial entity information demonstrating that the products will enhance the performance and sustainability of the municipality or institution or commercial entity based on the dynamic simulation model.

Implementations may include one or more of the following features. The dynamic simulation model may include a model also used by the municipality or institution or commercial entity. The dynamic simulation model may include a model also used by financers of development projects for the municipality or institution or commercial entity. The supplier may include a supplier of products, infrastructure, physical facilities or equipment, or services. The municipality or institution or commercial entity includes the city. The development projects include infrastructure projects. The supplier products can provide to financers of development projects information demonstrating that the product will enhance the performance and sustainability of the municipality or institution or commercial entity based on the dynamic simulation model.

In general, in an aspect, financers of development projects or operations and policies of a municipality or institution or commercial entity can have access to a calibrated and tested dynamic simulation model of the municipality or institution or commercial entity to determine a relationship between a proposed development projects or operations and policies and performance and sustainability of the municipality or institution or commercial entity and its financings and development. The financers are provided with information about products to be supplied to the municipality or institution or commercial entity to implement a development project or operation. The financers can establish proposed terms under which the financers will finance the products to be supplied to the municipality or institution or commercial entity based on operation of the dynamic simulation model.

Implementations may include one or more of the following features. The dynamic simulation model includes a model also used by the municipality or institution or commercial entity. The dynamic simulation model includes a model also used by suppliers of the products. The municipality or institution or commercial entity includes the city. The municipality or institution or commercial entity includes the city or contiguous cities or towns. The development project includes an infrastructure project. The products include physical facilities or equipment, or services. The financers are enabled to determine risks and rewards of the development project based on operation of the dynamic simulation model. The proposed terms include a type of investment vehicle and a level of return on the investment.

In general, in an aspect, a calibrated and tested dynamic simulation model of the municipality or institution or commercial entity is operated on behalf of the municipality or institution or commercial entity to generate information that enables the municipality or institution or commercial entity to make decisions about development projects or operations and policies that will enhance the performance and sustainability of the municipality or institution or commercial entity. The municipality or institution or commercial entity can expose the information to suppliers of products associated with the development projects or operations and policies and to financers of the products.

Implementations may include one or more of the following features. The dynamic simulation model is operated by the municipality or institution or commercial entity. The dynamic simulation model is operated by a party other than the municipality or institution or commercial entity, on behalf of the municipality or institution or commercial entity. The dynamic simulation model spans all of the development projects of the municipality or institution or commercial entity. The dynamic simulation model spans all operating activities and major policies of the municipality or institution or commercial entity. The dynamic simulation model is tested using historical data about the operation of the municipality or institution or commercial entity.

In general, in an aspect, a municipality or institution or commercial entity executes a development project that includes physical facilities or equipment, or services, based on information provided by a calibrated and tested dynamic simulation model of the municipality or institution or commercial entity. The municipality or institution or commercial entity operates the development project in accordance with the dynamic simulation model.

Implementations may include one or more of the following features. The development project includes an infrastructure project. The dynamic simulation model spans at least one other development project of the municipality or institution or commercial entity. The municipality or institution or commercial entity shares information generated by the dynamic simulation model with a supplier of the physical facilities or equipment, or services. The municipality or institution or commercial entity shares information generated by the dynamic simulation model with financers of the physical facilities or equipment, or services. The dynamic simulation model spans operations and policies of the municipality or institution or commercial entity. The physical facilities or equipment include roads, water systems, or sewer systems. The physical facilities or equipment include transportation systems, traffic control systems, or parking systems. The physical facilities or equipment include building automation and control systems. The physical facilities or equipment include power generation, distribution, or control systems.

These and other aspects, features, and implementations, and combinations of them, can be expressed as methods, methods of doing business, computer program products, systems, components, hardware, software, means and steps for performing functions, and in other ways.

Other aspects, features and implementations will become apparent from the following description, and from the claims.

### DESCRIPTION

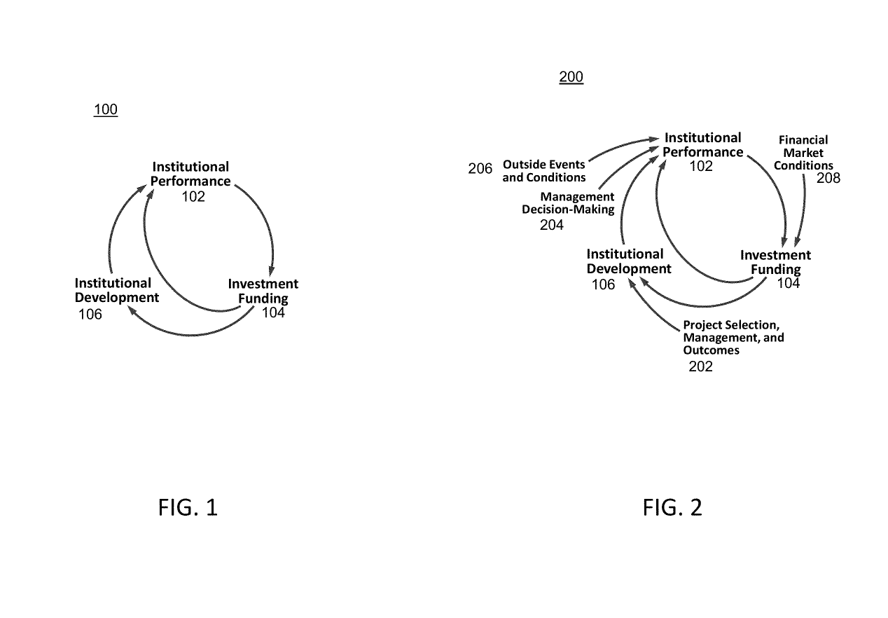

FIGS. 1 and 2 are diagrams of feedback relationships.

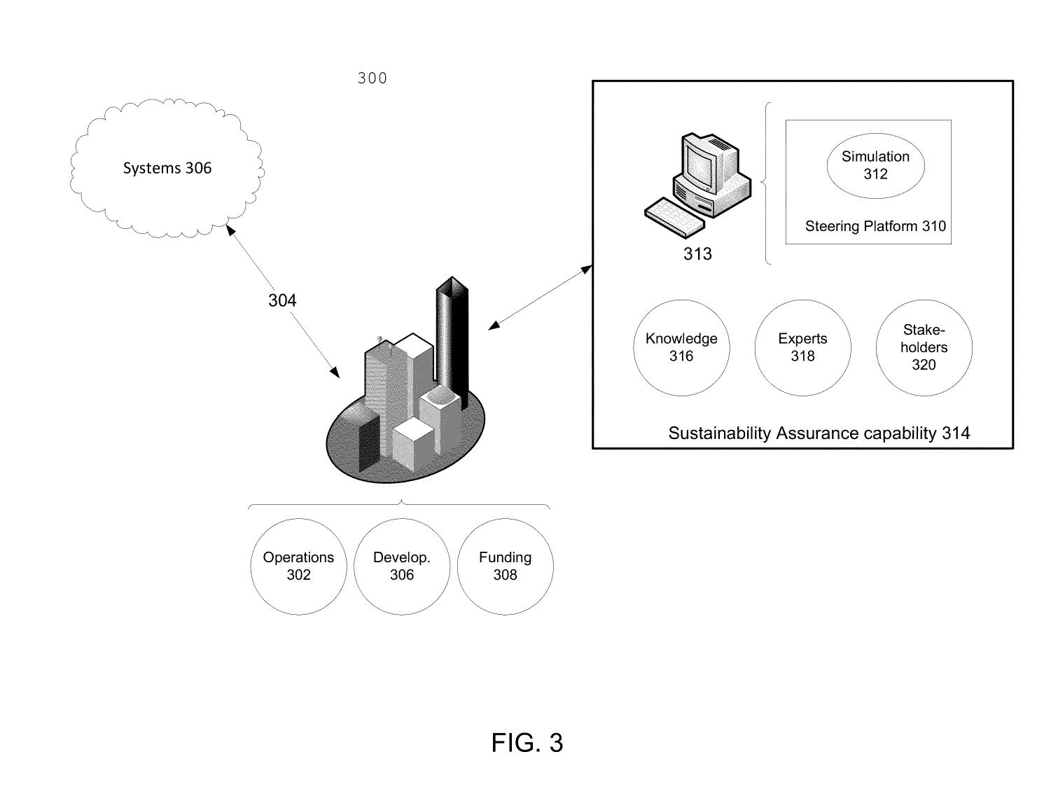

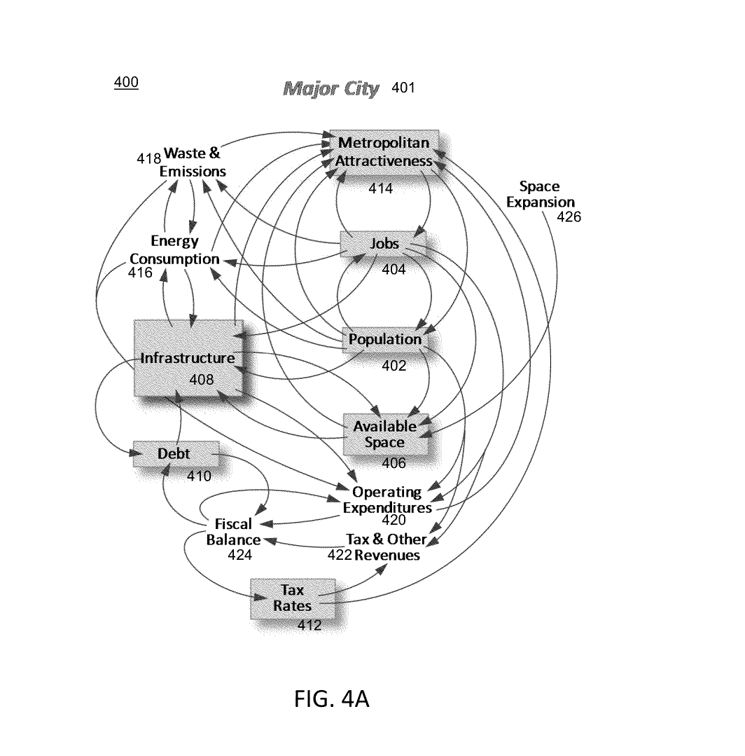

FIG. 3 is a system diagram.

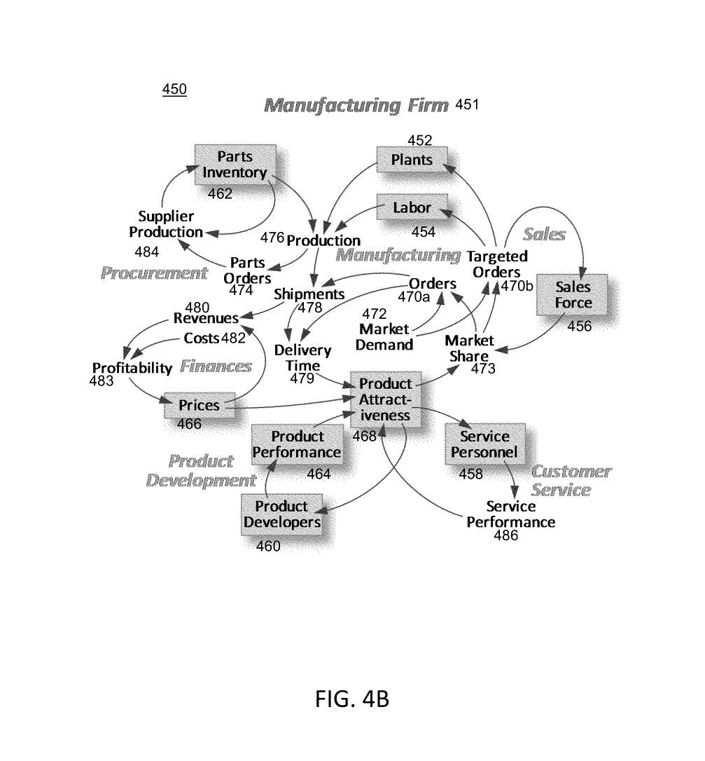

FIG. 4A is a diagram of a city.

FIG. 4B is a diagram of a firm.

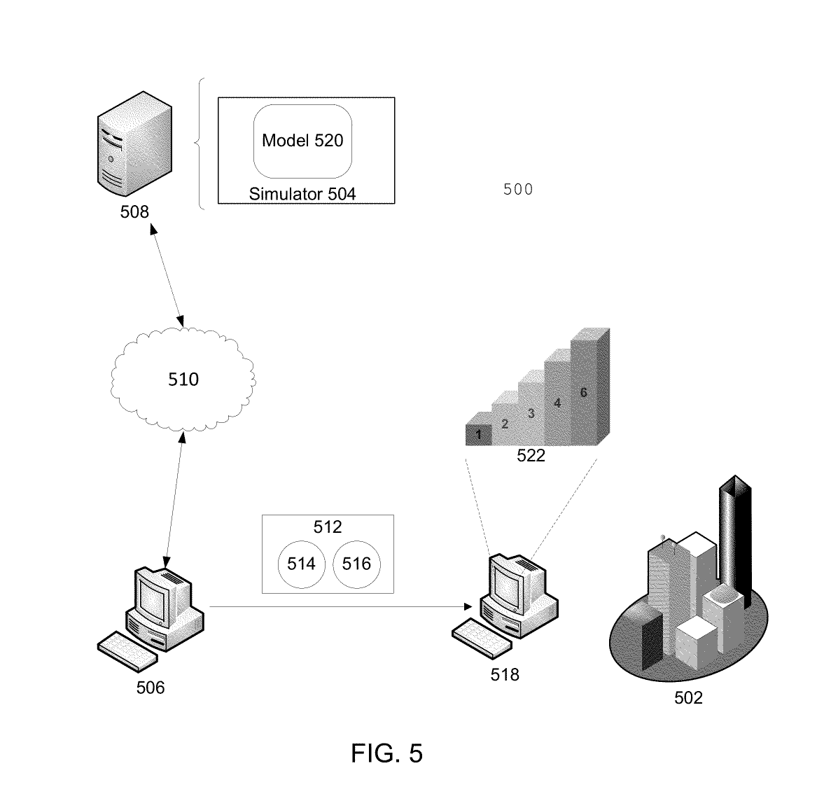

FIG. 5 is a system diagram.

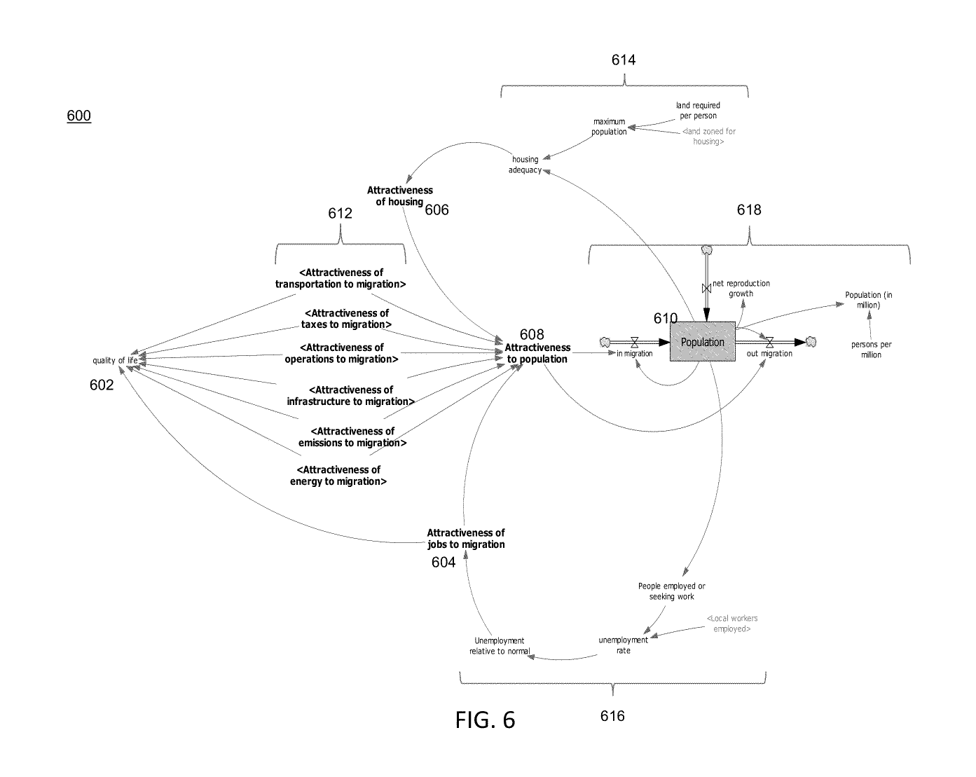

FIG. 6 is a simulator diagram.

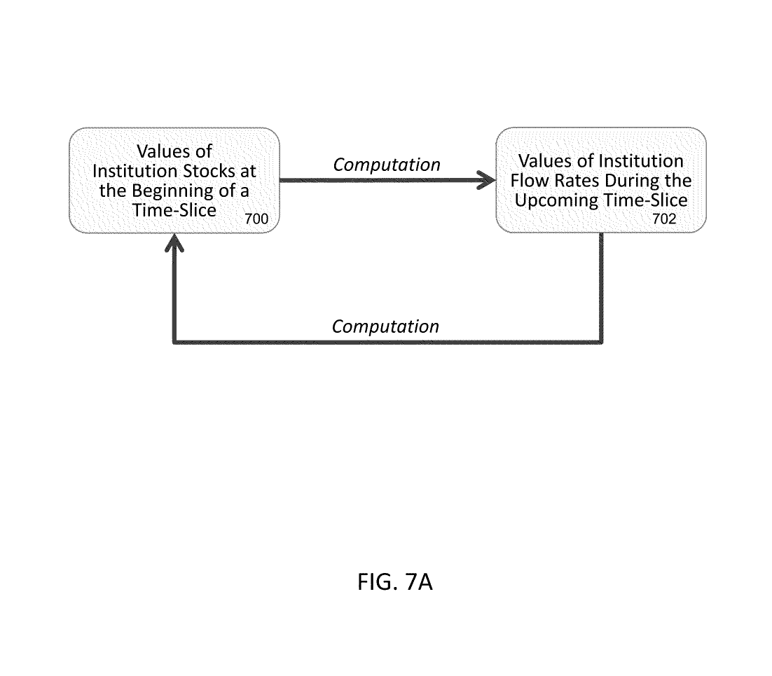

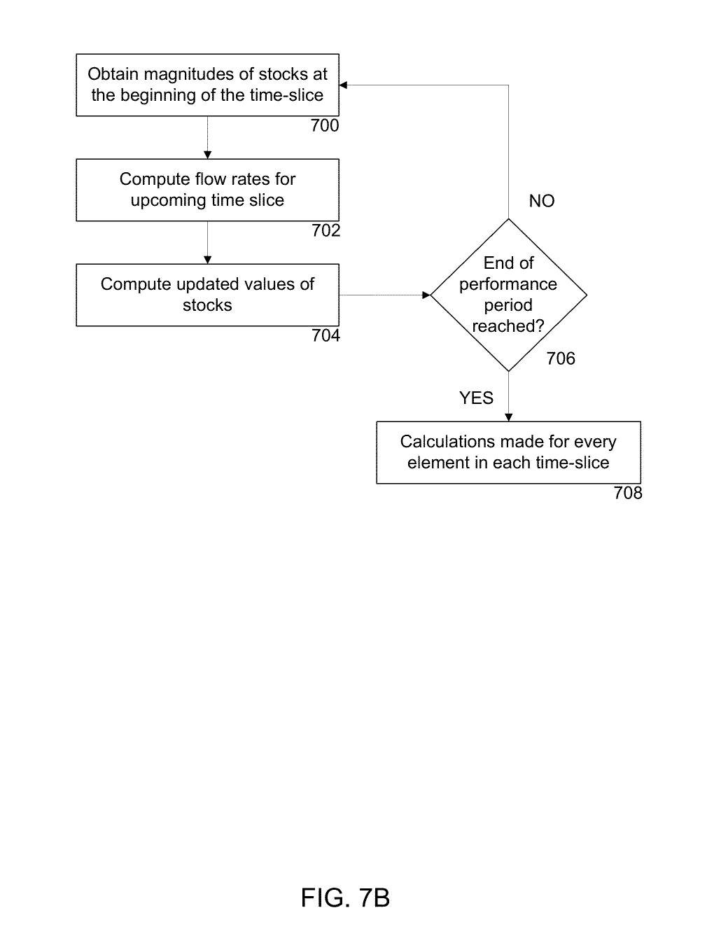

FIGS. 7A and 7B are flow charts.

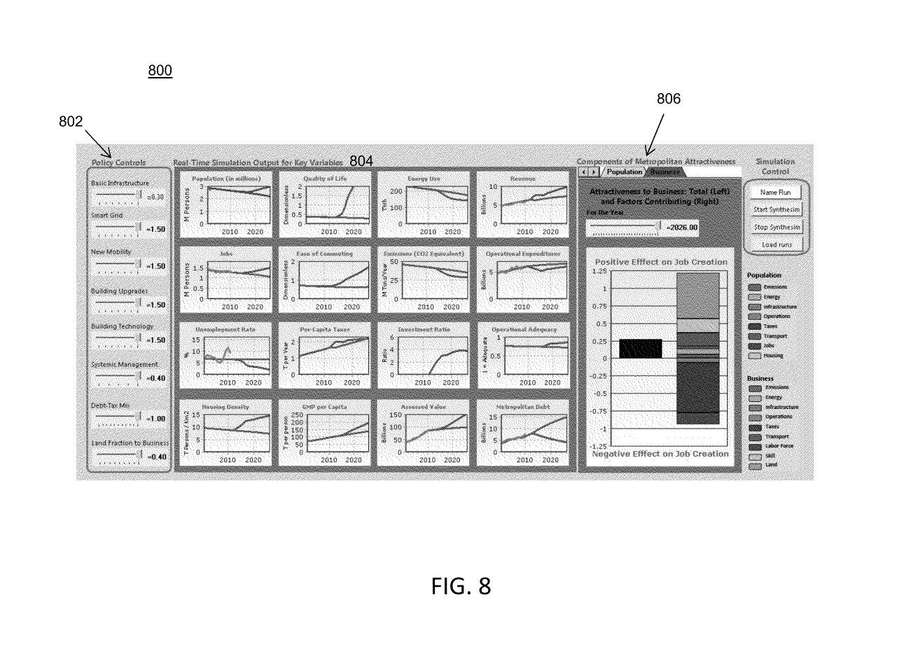

FIG. 8 is a screenshot.

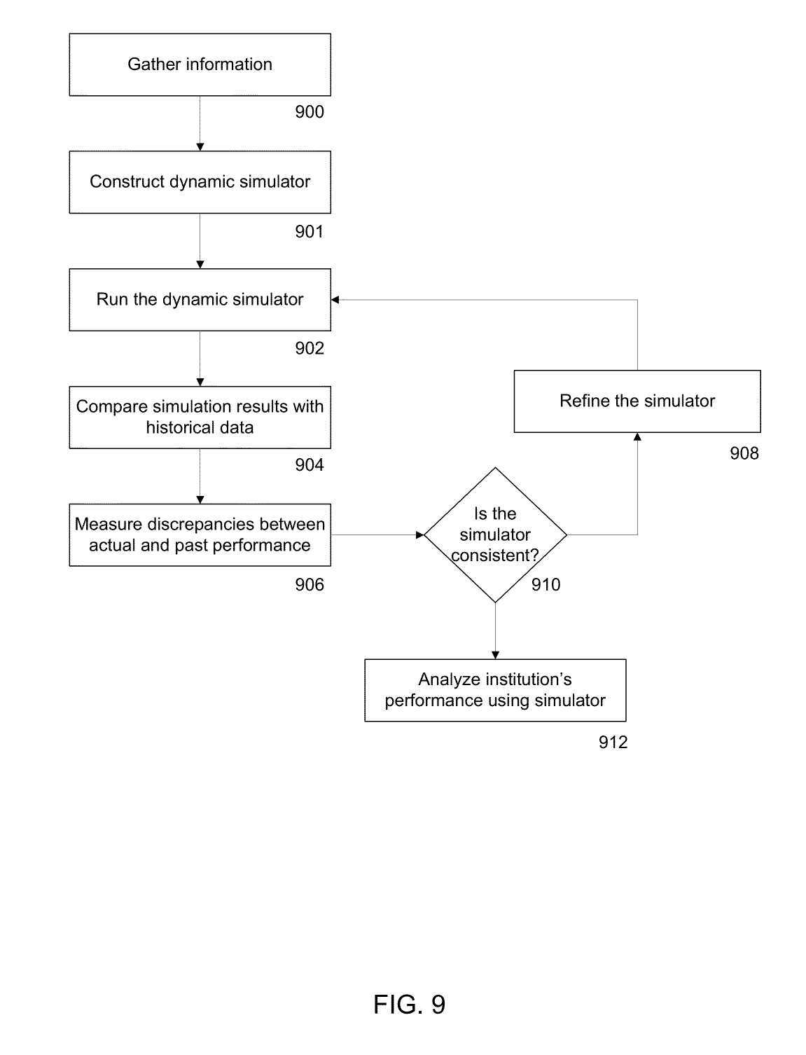

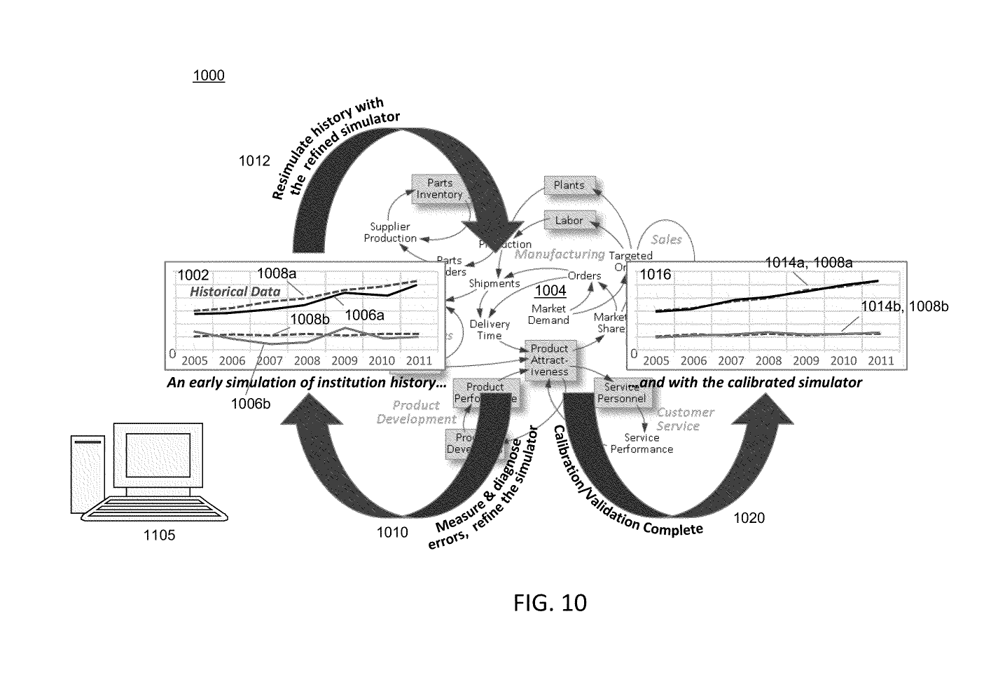

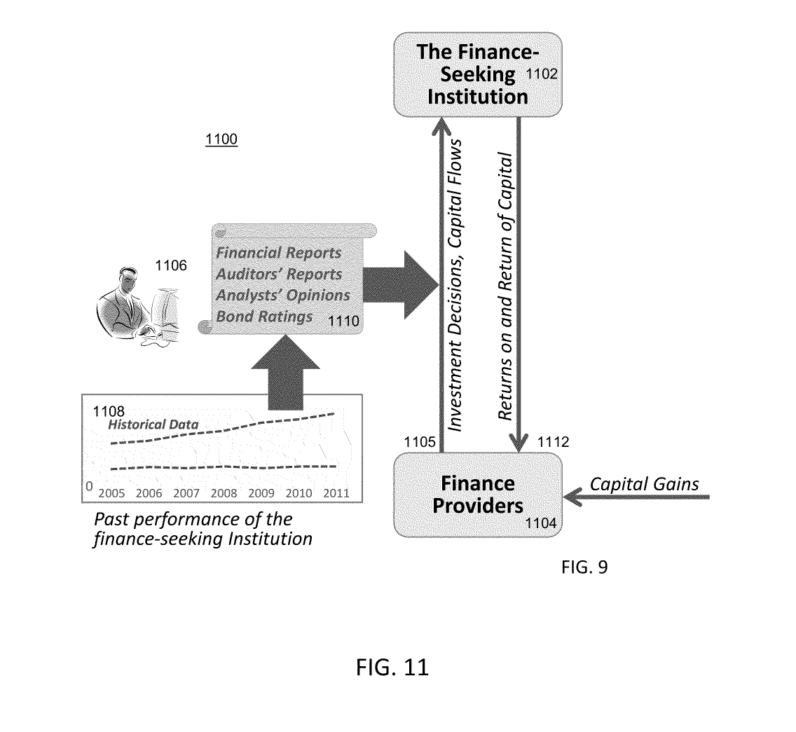

FIG. 9 is a flow chart.

FIG. 10 is a diagram of falsification testing.

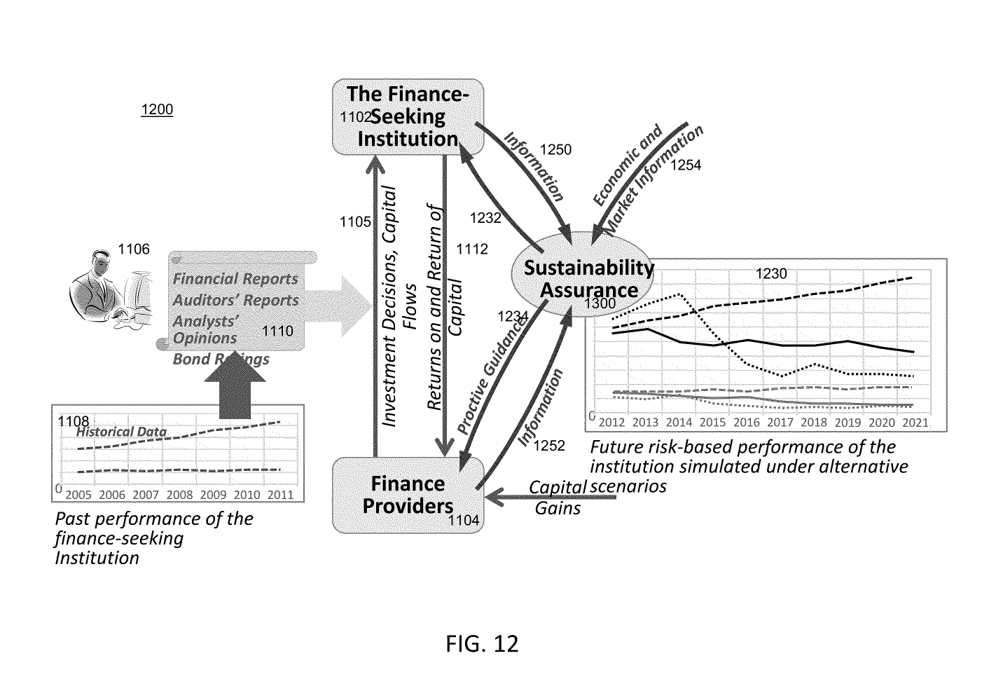

FIGS. 11 and 12 are diagrams of finance processes.

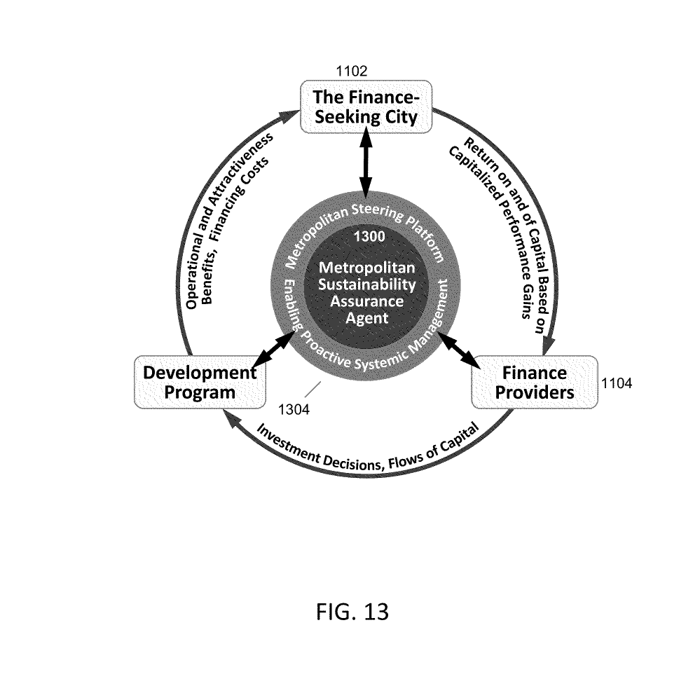

FIG. 13 is a flow diagram.

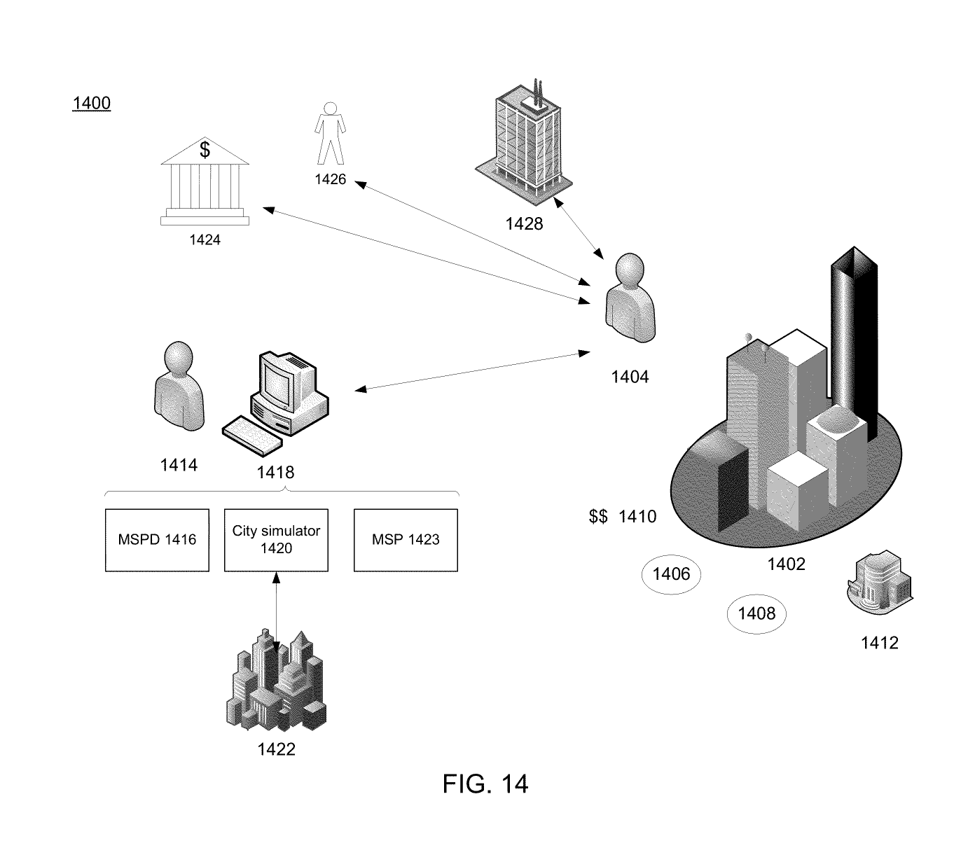

FIG. 14 is a system diagram.

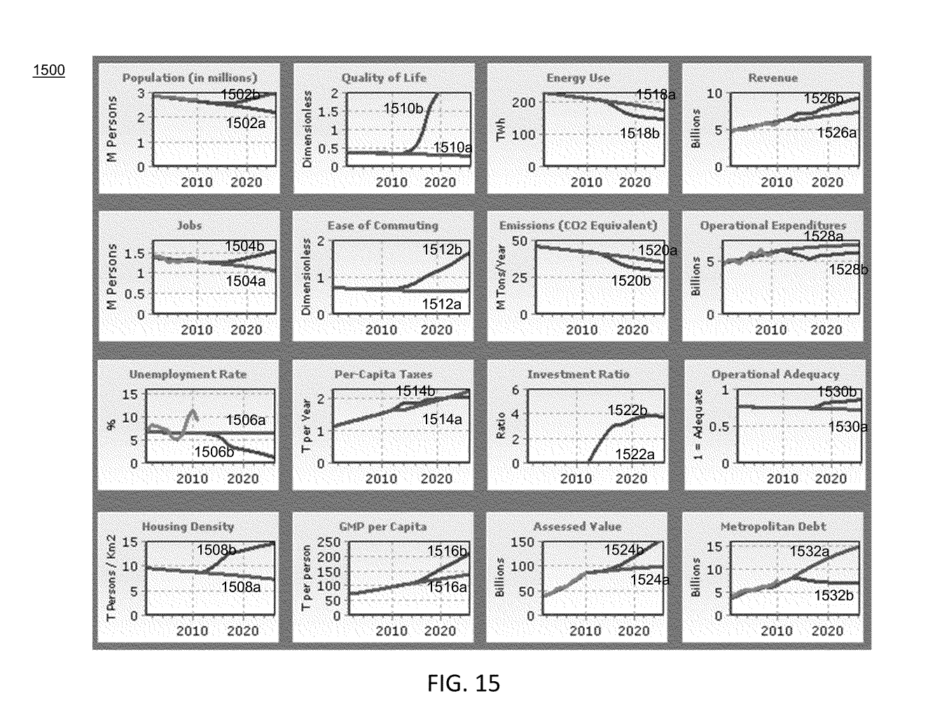

FIG. 15 is a screen shot.

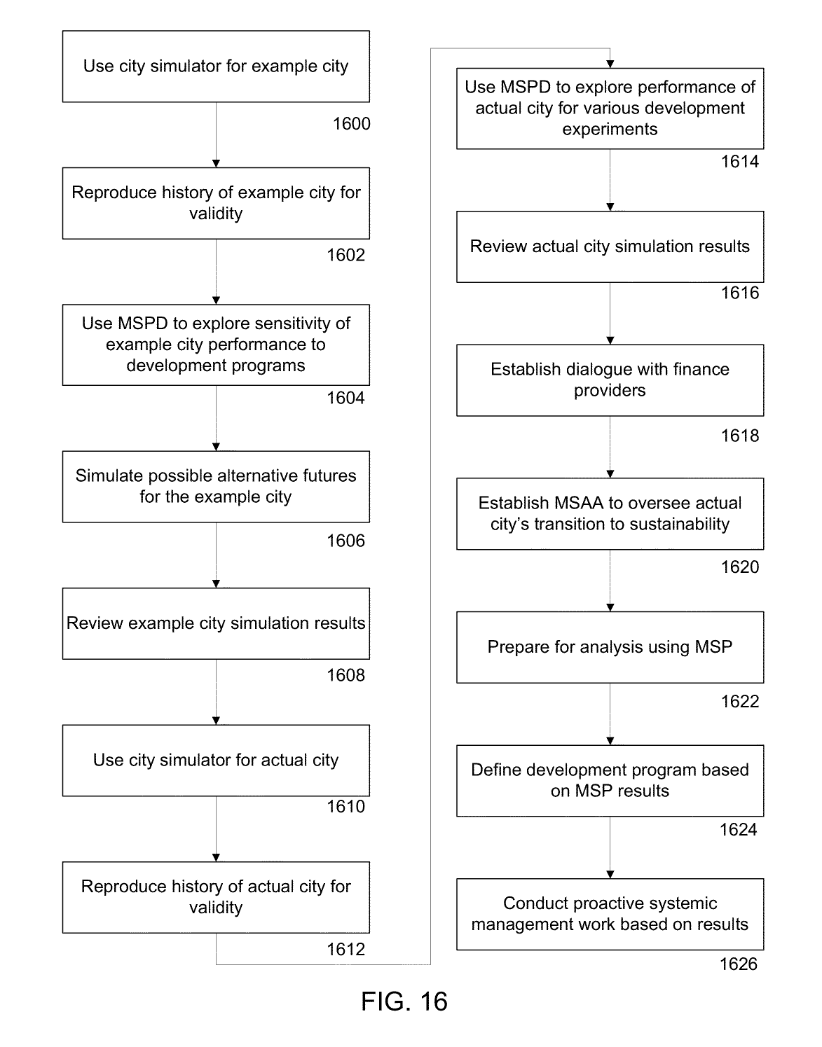

FIG. 16 is a flow chart.

### I. A METHOD FOR SUSTAINABLE PERFORMANCE, DEVELOPMENT, AND FINANCE IN MODERN INSTITUTIONS

Introduction.

The systems and methods presented here employs advanced computer simulation technology and other forms of prior art in a new, multifaceted, systemically proactive form of management and financing to make modern institutions sustainable.

Many institutions (e.g., corporations, privately-held firms, governments, other complex organizations and entities, or other institutions) are not sustainable, in the sense that they are not or will not be able to sustain their performance and in some cases their existence in the face of changing internal and external conditions. Examples are rife: mature cities in decline and fast-growing cities struggling to cope with in-migration and pollution; investment banks that vanish almost overnight when their business model no longer fits with fast-changing market conditions; national, regional, and local governments with fiscal deficits and growing debt; unions with declining membership and income, and commitments to union members that cannot be met; corporations suffering falling margins and market shares; rapidly growing unfunded liabilities for employers, pension funds, and insurance companies. For instance, corporations are often thought to be among the most flexible and adaptive of modern institutions, and yet the average lifespan of a company listed in the S&P 500 index has fallen from 67 years (in the 1920s) to just 15 today.

That many such institutions appear to be sustaining themselves is an illusion stemming from broad societal inability to see and understand and manage the real determinants of sustainability—which is a systemic phenomenon. A system is a group or combination of interrelated, interdependent, or interacting elements forming a complex, functioning whole. It is that whole which drives performance and determines the sustainability of any system, rather than its individual elements. Where performance and sustainability are concerned, the whole of any system is dynamically much greater than the sum of its component parts. The system will be unsustainable if those responsible cannot anticipate and proactively modify its systemically-driven performance in the face of changes.

Modern institutions are dynamically complex systems connecting to and dependent on other such institutional systems, all of which operate within even larger dynamic systems such as economies (ranging from regional to global), industries, markets, financial systems, energy systems, populations, societies, regional environments and the larger global environment. We live and operate in a global system of systems that is rapidly increasing its connective complexity, that is, its systemicity. Yet human beings are not accustomed to thinking or acting systemically—doing so is not intuitive and few of our traditional tools and methods support a systemic approach. All problems of institutional sustainability result from operating complex dynamic systems without systemic knowledge, understanding, anticipation, and management capability.

In many cases, the sustainability of an institution depends on one or more of the following three things: 1) its performance in the face of uncertainty; 2) development initiatives to alter capabilities and performance in the face of changing conditions; and funding to fuel development. These often constitute the three main facets of sustainability for an institution, in which case all three must usually be sustainable for the institution as a whole to be sustainable. The method outlined in this application employs advanced simulation technology in a new form of proactive systemic management that can make such sustainability achievable for most institutions.

The importance of making modern institutions sustainable can be seen in this fact: unsustainable behavior and performance by institutions is the driving cause of sustainability problems in the global environment. National and global regulation will probably prove insufficient to bring about environmentally sustainable behavior from otherwise unsustainable institutions (governments and regulatory agencies included)—that is today's equivalent of the medieval alchemist's quest to transform lead into gold. Achieving environmental sustainability is likely to require that we render sustainable the institutions whose currently unsustainable behavior is causing environmental unsustainability. There are no equilibria in the global system of systems in which those institutions live and operate, therefore eternal development is likely to be the price of sustainability—everything must continually change in order for things to remain as they are. Ultimately, global environmental sustainability will probably depend on our making development itself sustainable.

What Makes an Institution Unsustainable.

A sustainable institution evolves continuously and in a systemically effective manner so that it remains viable and performs well in the face of changing internal and external conditions. Modern institutions evolve through development on multiple dimensions including, e.g., development of new products, services, methods, processes, structures, technologies, data, resources, infrastructure, capacity, capabilities, or other dimensions, or a combination of any two or more of them. Development, in turn, depends on investment funding from within (profits), from finance providers, or from both.

Referring to FIG. 1, institutional performance, development, and funding are connected to each other in a relationship 100. The institution's performance 102 determines the availability of internal and external investment funding 104; funding 104 fuels development 106 and affects financial performance 102; and the outcomes of development projects 106 shape the institution's performance capabilities 102.

The causal connections between performance 102, funding 104, and development 106 form a powerful feedback mechanism represented by the relationship 100, and how that mechanism 100 operates determines the sustainability of a wide range of modern institutions, e.g., from Apple Corporation to the Paris Opera, from the City of London to Greenpeace. The performance 102 of a sustainable institution generates and attracts investment funding 104 in volumes sufficient to support needed development 106. If those funds 104 are then employed effectively in performance-enhancing development initiatives 106, the feedback mechanism 100 operates in a beneficially self-reinforcing manner (a ‘virtuous circle’) and the institution is sustained and sustainable.

That feedback mechanism 100 can also operate with opposite effect. If funding 104 falls short or development initiatives 106 are ineffective or the institution's performance 102 (including the full range of societal impacts) is unsatisfactory, this feedback 100 may become destructively self-reinforcing (a ‘vicious cycle’). Absent restorative change the institution may be unsustainable. Reduced funding 104 will tend to limit development, institutional performance 106 can easily stagnate or decline, and investment funding 104 may be further restricted as a consequence. If caught in the self-perpetuating ‘downward spiral’ that this feedback mechanism 100 can generate, the institution will be unsustainable absent some change in the driving dynamics. Sometimes the spiral operates slowly, as in a mature city in gradual decline, at other times it moves with lightning speed, as when Lehman Brothers lost access to traditional funding sources early in the global financial crisis. But slow or fast, some form of that feedback-driven downward spiral is usually operating in an institution that has become unsustainable.

Referring to FIG. 2, performance 102, funding 104, and development 106 depend not just on each other but on additional internal and external factors in a relationship 200.

Some of those additional factors are under the control of the institution's managers: selection and management of investment projects 202 aimed at enhancing performance 102 and other management decisions 204 that may influence the institution's sustainability. Events and conditions 206 outside the institution (including those in financial markets 208) generally cannot be controlled by the institution's managers. It is often assumed that management has its own decisions well in hand and therefore outside factors constitute the main threat to institutional sustainability, but that can be an illusion. Management's own decisions 202, 204 usually play a key role in sustainability problems, either in their own right (bad investment project selection 202 or other decisions 204 that conflict with sustainability, for example), or because management fails to make sufficient allowance for possible sustainability consequences of outside factors.

The Root Causes of Unsustainability.

Sustainability problems and the management decisions that lead to them usually result from one or more of the following closely related causes:
1) Institutional sustainability and unsustainability are systemic phenomena, produced by the same complex feedback mechanisms that drive the performance of the institution and of its development projects;
2) Traditional methods and analysis tools typically shed little or no light on dynamic feedback; the resulting performance of the institution and its development projects; potential threats to sustainability; or what can be done to make the institution sustainable; and
3) Normally, human beings cannot reliably intuit how these complex dynamic systems behave or how to favorably influence system performance.

Where issues of dynamics and sustainability are involved, traditional methods tend to be so inadequate and systems so counterintuitive that many managers mistakenly believe their institutions to be sustainable. Traditional analyses tend to be lagging rather than leading indicators of sustainability problems, giving warning only when the threat has become severe enough to be obvious without analysis and too late for systemically effective action. To say that is not a criticism of traditional methods and tools, few of which were designed to deal with the complex feedback mechanisms that drive the performance and sustainability of complex institutions. Furthermore, many traditional methods and tools are important contributors to the advanced dynamic simulators that are required for reliable analysis of sustainability issues.

But traditional methods and tools alone will usually be insufficient to address the systemic phenomenon of sustainability in complex modern institutions. These methods and tools leave managers in a difficult position, e.g., making decisions with little information about the systemic interconnections through which consequences and outcomes usually occur. The following are examples of decisions made under such conditions which reduce the institution's sustainability instead of enhancing it:
Development projects selected are unlikely to produce performance improvements commensurate with their costs;
Management decisions are made in fragmentary fashion, as if different parts of the institution operated in isolation from each other and from the external systems with which the institution interacts—such decisions often compete or conflict systemically and sharply sub-optimize performance; and
Not knowing the location of the systemic ‘high-leverage’ points to which their performance is particularly sensitive, managers often fail to recognize resulting vulnerabilities, make damaging decisions without realizing they are doing so, and fail to sufficiently protect those vulnerable points against the possibility of changing conditions.

These difficulties are usually more than just problematic, they often represent the path by which institutions render themselves unsustainable through accumulating decisions and actions which are at odds with the systemic realities driving performance. Institutions usually become unsustainable because they lack reliable systemic understanding, anticipation, analysis, and proactive change capability.

To make an institution sustainable will usually bring a synergistic and transformative combination of benefits, including, e.g., one or more of the following: i) it preserves a great deal of accumulated societal capital/value that would otherwise be eroded or destroyed; ii) it maintains the institution as a dynamic value-creating engine; and iii) it increases the future value-creation capacity of that institution. Consequently making institutions sustainable is relevant to making societies sustainable.

Preview of the Business Method.

Referring to FIG. 3, making an institution 300 sustainable involves one or more of the following three primary and inter-dependent elements:
1) Proactive systemic management encompassing the institution's 300 ongoing operations 302 and interactions 304 with other systems 306, its program of development initiatives 308, and its investment funding 310;
2) A tailored computerized dynamic Steering Platform 310 enabling and supporting the institution's 300 practice of proactive systemic management, employing advanced dynamic simulation technology 312 implemented on a computer 313;
3) Independently institutionalized Sustainability Assurance capability 314 housing and employing that Steering Platform and integrating diverse bodies of knowledge 316, expert capabilities 318, and stakeholder groups 320 required for proactive systemic management.

By “proactive” we mean: preparing for, intervening in, or controlling an expected occurrence or situation; tending to initiate change rather than reacting to events. Managers and institutions may engage in numerous ostensibly proactive decisions and actions that do not reflect systemic anticipation. Few such actions can be properly systemic in the absence of reliable means for anticipating the performance of institutions-as-systems and of other systems with which those institutions interact. Dynamic simulation technology is well and widely proven as an instrument for systemic anticipation and proactive change, offering an unmatched combination of speed, breadth of coverage, and reliability. Yet few institutions are presently aware of or make use of such technology, and exceptions involve only narrow and limited applications. Consequently, from the standpoint of sustainability as a systemic phenomenon, decisions and actions by managers of institutions are often reactive rather than proactive—taken in after-the-fact response to systemic performance and influences because they have no reliable means of anticipating and preparing for their consequences. That underlying reality makes it difficult or impossible for institutions to sustain themselves.

Proactive systemic management is made possible by an institution-specific Steering Platform 310 that combines dynamic simulation technology 312 with complementary methods and technologies to enable and support systemically effective decision-making by institution managers. That involves a profound change because present decision-making is generally quite reactive with respect to the three factors on which institutional sustainability may depend, such as, e.g., performance, development, or funding. Reliably supported proactive decision-making will tend to shift the institution's 300 risk-reward frontier bodily outwards, making it possible to simultaneously improve performance and reduce risk relative to what can be achieved with traditional management approaches alone. Moving the risk-reward frontier is both a product and an enabler of institutional sustainability—reflecting the self-reinforcing ‘virtuous circle’ that underlies sustainability. The change to proactive systemic decision-making is the primary technological contribution of the institution's Steering Platform 310 to the quest for sustainability.

The institution's Steering Platform 310 is the repository providing an integrative structure for the diverse knowledges 316 essential to proactive systemic management. The Platform 310 is a force-multiplier for those knowledges 316, adding value both by their integration and by the power of dynamic simulation 312 to transform them into systemic understanding and wisdom. The Platform 310 is also the vehicle for integrating the numerous and diverse capabilities 318 involved in making an institution 300 sustainable. Some of those capabilities 318 may reside within the institution 300, many may be found outside of it, and the Platform 310 provides the integrating and organizing focus for them all. Finally, the Steering Platform 310 makes the institution's 300 process of proactive systemic decision-making visible and accessible to stakeholder groups 320 and includes them in that process. These three forms of integration are the primary infrastructure and process contributions of the institution's Steering Platform 310 to the quest for sustainability.

Sustainability Assurance is a new capability, an enabler of the ongoing managed change process relevant for an institution to be sustainable. Sustainability Assurance includes the setup, maintenance, and operation of the institution's Steering Platform 310, integration of requisite knowledges 316 and their incorporation in systemic analyses, making the technology and process accessible to the institution 300 and its many stakeholders 320, and guiding the systemic proactive management process relevant for sustainability. The Sustainability Assurance capability should operate objectively, serving the mutual interests of the institution 300 and its stakeholders 320 in the sustainability of that institution. The capability may reside with a Sustainability Assurance Agent, an organization tailored and dedicated to the sustainability of the institution 300 in question.

### II. TECHNOLOGY: DYNAMIC SIMULATION, SYSTEMIC ANALYSIS, AND PROACTIVE SYSTEMIC MANAGEMENT

Dynamic simulation is the technological process of reproducing a dynamically complex system (an institution) and other systems with which it interacts in validated computerized form (the simulator) for the purpose of simulating performance under a variety of conditions. Systemic analysis is the process of using the simulator to analyze, understand, and anticipate the performance of that system as influenced by related systems which affect its performance. Systemic management is the process of using that understanding to devise, test, and implement measures to alter the anticipated performance of the institution to achieve specific objectives. There are several forms of dynamic simulation and related technology pertinent to the sustainability of institutions, beginning with System Dynamics as developed at MIT in the 1960s. Dynamic simulation technology is used for proactive systemic analysis and management and may make possible substantial performance gains and sustainability for the institution.

The systemic structure of an institution is a network formed by its component elements and by the relationships or connections between those elements. Stocks and flows (or levels and rates) are the systemic building-blocks of the institution's structure.
Stocks are real-world accumulations of things which could be counted if all system action were to be frozen in time. For instance, you can count the number of employees, products, and buildings in a corporation or the number of citizens, jobs, automobiles, and buildings in a city, and you can measure the perceived attractiveness of the city or the corporation's products—these are all stocks.
Flows are the real-world processes that cause stocks to increase or decrease. As embodiments of action, flows could not be counted if all system action were to be frozen. Flows are evidenced and measured by their consequences, that is, by the changing values of the stocks that they increase and decrease. Corporate flows include, e.g., employee arrivals and departures, product introductions and discontinuations, changes in perceived product attractiveness, building acquisition/construction/disposal, and other flows. Metropolitan flows include, e.g., citizen in- and out-migration, job gains and losses, traffic inflows and outflows, building construction/demolition, and other flows.
Within real-world systems stocks and flows may affect each other—flows can change the value of stocks, stocks can shape the magnitudes of flows, or both. For example, corporate or government hiring (a flow) increases the number of employees (a stock), and the number of employees (the stock) also drives management decisions about future hiring (the flow). That is an example of system feedback, in which the magnitudes of system stocks today affect flows during the next few months which may, in turn, determine the magnitudes of those stocks a few months in the future.

Feedback is a causal phenomenon and a distinguishing characteristic of dynamically complex systems including modern institutions, markets, economies, etc. Feedback is inherent in the structural network of such systems, takes place constantly, and is the primary driver of their performance. The term dynamics refers to motivating or driving forces, and when applied to dynamically complex systems it means the performance-driving forces produced within and by the feedback structures of those systems. The performance-dominating role of system feedback distinguishes dynamically complex systems from other types.

Referring to FIGS. 4A and 4B, feedback mechanisms 400, 450 typical of complex modern institutions such as a major city and a manufacturing firm, respectively. For purposes of this discussion the entire city is the institution referred to, not just the city government. FIGS. 4A and 4B show, at a summary level, a structure 401 of the city and a structure 451 of the firm as dynamic systems comprised of stocks and flows (with boxes designating the stocks and arrows designating the flows, both of which we also refer to as nodes).
Stocks in the city 401 may include, e.g., metropolitan population 402 and number of jobs 404, the amount of available metropolitan space 406 of various types (open land and buildings), the amount of infrastructure of various types 408, accumulated debt 410, the level of taxation 412, and overall metropolitan attractiveness 414. Flows may include, e.g., energy consumption 416, generation of waste and emissions 418, expenditures 420 and revenues 422, fiscal balance 424, and space expansion 426.
Stocks in the manufacturing firm 451 may include, e.g., the amount of plant capacity 452, the number of employees in various categories (e.g., manufacturing labor 454, sales force labor 456, service personnel 458, and product developers 460), the size of the manufacturer's parts inventory 462, the performance characteristics of current products 464, product prices 466, and overall product attractiveness 468. Flows may include, e.g., customer orders 470a, 470b, e.g., related to market demand 472, market share 473, or both; parts orders 474; production 476, shipments 478, and delivery times 480; revenues 480 and costs 482; profitability 483; supplier production 484; provision of customer service 486; and changes in the performance characteristics of products.

The various nodes (i.e., stocks) shown in these systemic institution diagrams fall into two categories: 1) a first category (e.g., a majority of the nodes) to which performance of the institution is relatively insensitive; and 2) a second category (e.g., a small remainder) to which the institution's performance is disproportionately sensitive. Nodes in this second category are referred to here as “high-leverage points.” Empirically the high-leverage points may constitute, e.g., something less than 5% of all nodes in the performance-driving system network. Making changes at one or more of those points will usually have a disproportionately large influence on the institution's performance (for better or worse) and interventions at other points will usually make little or no difference. That is a consequence of the performance-determining role of systemic feedback—high-leverage points reside in the more potent feedback mechanisms of the institution, low-leverage points do not. The operation of feedback mechanisms within the institution can shift the relative potency of those mechanisms, as can outside influences. Thus the dominance of particular feedback mechanisms within the institution is dynamic rather than fixed, and shifting locations of systemic high-leverage points within those mechanisms cannot be reliably identified through any non-dynamic or non-systemic method of analysis.

Another important characteristic of the institution-as-system stems from the fact that its own feedback mechanisms dominate performance. Thus the performance of the institution tends to be generated mostly from within the structure of its own dynamic system. Even the influence of outside events and conditions is channeled through those systemic connections, altering performance as they affect the operation and shift the balance of the institution's built-in feedback mechanisms.

Simulating the Dynamics and Performance of a Complex Institution.

Referring to FIG. 5, a portion of an example dynamic simulation system 500 for a city 502 implements a dynamic simulator 504 on a computer 506. In some examples, the dynamic simulator 504 is hosted on the computer 506. In some examples, the dynamic simulator 504 is hosted on a server 508 that is accessed via a communications network 510, such as the Internet. Information 512 about the institution 502, such as stocks 514 and flows 516, is provided to the dynamic simulator 504, e.g., by direct entry into the computer 506 or via the network 510 from a computer 518 at the institution 502. Based on the information 512, the dynamic simulator 504 generates simulations 520 of the institution 502 and in some cases of other systems with which the institution interacts 502. The simulation 504 constitutes retrospective or predictive results 522 about the institution, which can be displayed on a user interface of the computer 506, the computer 518, or both.

Referring to FIG. 6, in one example, a city simulator 600 simulates the effect of various factors on the quality of life 602, the attractiveness of jobs to migration 604, the attractiveness of housing 606, the attractiveness to population 608, and the population itself 610. These factors may include attractiveness factors 612 including, e.g., the attractiveness of transportation, taxes, operations, infrastructure, emissions, energy, or other attractiveness factors, or a combination of any two or more of them to migration. The factors may include housing factors 614 including, e.g., the land per person, the land zoned for housing, the maximum population, the housing adequacy, or other housing factors, or a combination of any two or more of them. The factors may include employment factors 616 including, e.g., people employed or seeking work, local workers employed, the unemployment rate, the unemployment relative to normal, or other employment factors, or a combination of any two or more of them. The factors may include population factors 618 including, e.g., in-migration, out-migration, net reproduction growth, population, persons per million, or other population factors, or a combination of any two or more of them. As can be seen from FIG. 6, many of these factors are interrelated in a complex network.

The dynamic simulator of an institution reproduces (in computerized form) the stocks and flows that form the feedback mechanisms driving the institution's performance. The simulator equations compute the values of the institution's component stocks and flows over the simulated period of performance. Those equations are simple, explicit, and auditable statements of which flows affect each stock on the project and which stocks affect each flow, and how those effects operate and are computed. The equations operate in short time-slices of a few days or a week in duration.

Referring to FIG. 7A, in general, the simulator determines (e.g., by calculation or from input data) the values of institution stocks at the beginning of a time-slice (700). The simulator then computes the values of institution flow rates during the upcoming time slice (702). Based on those flow rates, the simulator can then compute the values of institution stocks at the beginning of the subsequent time-slice (700).

More specifically, referring to FIG. 7B, the computation cycle begins with the magnitudes of all stocks in the institution at the beginning of each time-slice (700), based on which the values for all institution flow rates are computed for the upcoming time-slice (702). At the end of that time-slice those flow rates are used to compute the updated values of all of the institution's component stocks (704). This computational cycle starts with the initial values of the institution's stocks (at the beginning of the simulation) and steps forward one time-slice after another to the end of the simulated period of performance (706). At that point, calculations have been made for every element in each feedback mechanism of the institution in each time-slice from the beginning to the end of the simulation period (708).

In principle the values of the institution's stocks and flows can be computed manually or in a spreadsheet, although making and checking such calculations for any real-world institution would be slow, tedious, and prone to arithmetic errors, and the spreadsheet would be large, clumsy, and inefficient to construct and debug. Dynamic simulation software (several products are available commercially) automates the relevant calculations across all the time-slices. This software makes it easy to represent the component feedback mechanisms of an institution and to automate the computation of component stocks and flows over time. This software also makes the stocks, flows, and calculations accessible for review and audit in several forms: diagrams; equations; and numerical outputs.

FIG. 8 shows an example screenshot including an output summary from a simulator of a major city. A policy controls panel 802 includes tools for setting simulator inputs characterizing the magnitude, mix, or both, of projects in the city's development program. Real-time simulation outputs 804 provide graphs of the evolution of key variables in the simulator with time. For instance, graphs may represent the time evolution of variables such as, e.g., population, quality of life, energy use, revenue, jobs, ease of commuting, emissions, operational expenditures, unemployment rate, per capita taxes, investment ratio, operational adequacy, housing density, GMP per capita, assessed value, metropolitan debt, or other variables, or a combination of any two or more of them. An attractiveness panel 806 provides a graph-based view of the effect of various factors on the attractiveness of the city or on particular aspects of the city, such as job creation or population.

As in most dynamically complex systems, the managers of an institution generally may attempt to control performance by regulating selected stocks and flows, based on information feedbacks. This includes managerial reactions and responses to events or conditions from outside the institution which may influence performance through the operation and balance of the institution's feedback mechanisms. Dynamic simulation reliably replicates the component project stocks, flows, and feedback mechanisms, the influence of outside events and conditions on them, and the role of management decision-making in them. Compared to traditional (non-dynamic) forms of modeling, that capability of dynamic simulation substantially increases both the range of performance questions that can be answered about the institution and the demonstrable reliability of those answers.

In its representation of the institution's systemic structure, the dynamic simulator may include many (e.g., hundreds) feedback mechanisms that replicate those driving the performance of the real-world institution. That representation may include smaller or temporary systems that exist within or alongside the institution's overall dynamics. One example: the institution's program of development projects, each of which is a smaller, temporary, and still-complex system in its own right. Reproducing the institution's feedback mechanisms and subsidiary systems allows inclusion of some or all of the important performance-driving factors and contributes to the high analytical reliability for which dynamic simulation is known.

Simulator Calibration Via the Scientific Method.

Replicating the institution's feedback mechanisms sharply reduces the amount of input data to be provided to the simulator because the simulated feedback mechanisms compute internally some or all of the factors affecting performance. That sharp reduction in inputs allows data on historical performance of the institution to be employed not as simulator inputs, but as an independent benchmark for simulator calibration and validation under the Scientific Method. This is a major advance over traditional modeling methods, most of which employ historical data to drive the model—which means that data cannot be used for validation purposes. This key aspect of the dynamic simulation process contributes directly to the high reliability for which systemic analyses are known.

The Scientific Method involves four basic steps:

1) Forming a testable hypothesis;
2) Subjecting that hypothesis to rigorous falsification testing;
3) Measuring resulting failure or error rates; and
4) Using that information to refine and improve the hypothesis.

Repeating this process progressively strengthens the hypothesis and reduces error rates through successive rounds of falsification testing, which continue until the hypothesis is consistent with available information to within acceptably low error rates. When the hypothesis cannot be further falsified with available information, it constitutes the most reliable available basis for conducting analyses.

Referring to FIG. 9, in dynamic simulation of a complex modern institution, the process of the Scientific Method are as follows:
1) Gather information (900) and construct a dynamic simulator (901) representing the institution own performance-driving feedback mechanisms and those of related dynamic systems. That simulator is an explicitly stated hypothesis about the systemic causes of the institution's performance including outside influences;
2) Run the simulator to re-create the past performance of the institution (902), and compare that simulation with historical performance data for the institution (904). The simulator may be falsified in some way, e.g., if doesn't reproduce the institution's known history with acceptably low error rates;
3) Measure and diagnose discrepancies between the institution's simulated and actual past performance (906) as guides for improving the simulator (the hypothesis);
4) Refine the simulator's representation of the institution to make it more consistent with available corroborative information (908); and
5) Repeat the cycle of falsification testing and hypothesis refinement until the simulator is adequately consistent (910) with available information on the institution, as indicated by acceptably low error rates. When the simulator cannot be further falsified with available information, it is demonstrated to be consistent with that information and constitutes the best available vehicle for analyzing and understanding the institution's performance (912). If new information becomes available at some point, the falsification-testing and simulator-refinement process can be resumed.

A simulator that is not consistent with information about the institution (including its past-performance history) is not a reliable platform for analysis of its performance. Falsification testing under the Scientific Method is intended to identify flaws in the hypothesis embodied in the simulator—the process of finding and fixing such flaws is essential to establishing and demonstrating simulator reliability. The first simulations of an institution may contain inconsistencies with the historical record. Often those inconsistencies can be traced to some flaw in the simulator; sometimes they can result from flaws in available information for the institution. Specific discrepancies between the simulated and actual performance of the institution may indicate where and what sort of refinements are needed to harmonize the simulator and information about the institution. Regardless of their causes, the process of falsification testing and refinement relies on inconsistencies between the simulator and various forms of institution-specific information to point to potential improvements in both the simulator and the information.

Falsification testing is thus a process of triangulation (mutual consistency-checking and refinement) between three different types of information about the institution: (i) historical data characterizing its past performance; (ii) knowledge about the feedback mechanisms that drive the institution's performance, as represented in its dynamic simulator; and (iii) information about outside events or conditions that may have influenced the institution's performance during the period being simulated. In this triangulation process, falsification-testing one type of information constitutes equally rigorous falsification-testing for the other two information types as well—by testing one type of information against the others, all three types of information can be tested. Surviving falsification testing demonstrates consistency between these three complementary types of information—e.g., it demonstrates that there are no incongruities between performance data from the real-world institution, knowledge of that institution's performance-driving feedback mechanisms, and information about outside events and conditions that may have affected performance.

This multi-dimensional consistency has great analytical and anticipatory power. Because feedback mechanisms connect some or all elements of the institution to some or all other elements, in both the real world and in the simulator, it is unlikely that a significantly erroneous simulator can successfully re-create the institution's multi-dimensional performance history. Attempting to force an erroneous simulator to artificially re-create one aspect of the institution's performance history may “break” the simulator's ability to reproduce some other aspect of its history. Combined with the discipline of the Scientific Method, the interconnectedness of feedback mechanisms within the institution makes it difficult to compensate for a dynamic flaw in one part of the simulator with a hidden offsetting error in some other part.

Falsification-testing may uncover one or more inconsistencies or flaws in the institution's historical data, the characterization of performance-affecting events and conditions, or both—those can be remedied by reviewing and refining the relevant information. Falsification-testing may reveal areas for improvement in the simulator as well. For instance, sometimes testing reveals flaws in the stock-and-flow equations that define the institution's feedback mechanisms, and those can be remedied by refining the equations until they are consistent with available project information.

In some cases, simulator flaws may not be in the equations themselves but in their numerical inputs which characterize the strength and action-speed of the relationships between the institution's component stocks and flows. Such flaws can be remedied by adjusting the input parameters until they are consistent with available project information. That adjustment process is called calibration: the strength and speed of the institution's simulated feedback mechanisms can be calibrated to be substantially consistent with available information about the real-world institution. The standard of fidelity for the calibration aspect of falsification testing involves having the simulator reproduce the institution's known performance within accepted error-rate limits when measured against the independent benchmark of historical performance data.

Referring to FIG. 10, the calibration part 1000 of falsification testing proceeds iteratively in a large number of small increments. An early simulation 1002 of an entity 1004 by a simulator 1005 includes simulation results 1006a, 1006b (solid lines) that do not closely match actual historical data 1008a, 1008b (dashed lines). Each calibration increment includes making one or more refinements to the simulator/hypothesis 1005, followed by re-simulating 1012 the performance of the institution 1002 to obtain new falsification test results 1006a, 1006b against the historical-data benchmark 1008a, 1008b. The refined simulator will tend to behave somewhat differently at each increment—for instance, previously corrected discrepancies may disappear, new ones may be revealed, or both. The new falsification-testing results obtained in each step guide the next round of simulator refinements. The simulator 1005 is refined until simulation results 1014a, 1014b (solid lines) of a final simulation 1016 match 1020 actual historical data 1008a, 1008b within a predetermined degree of accuracy.

This iterative process progressively reveals the strengths and speeds of the causal relationships in the feedback mechanisms that drive the institution's performance. Those are fundamental and unique characteristics of that particular institution, just as DNA or fingerprints are unique to individual human beings. Like DNA and fingerprints, the strength and speed of those relationships are distinguishing traits of the institution and the systems with which it interacts, which tend to be stable over long periods and are not altered by changing outside conditions. Reliable quantification of those performance-driving characteristics of the institution, which can be obtained through the simulator-calibration process, makes it possible to anticipate and analyze the institution's performance over extended time periods with unusually high reliability and analytical speed.

Calibration and falsification testing end when remaining discrepancies between the real-world history of the institution and its simulated re-creation are acceptably small and no further improvements can be made using available information. At that point the simulator is consistent with available historical data and other information on the institution. The simulator has been validated, along with the strengths and speeds of the component causal relationships driving the institution's performance. The calibration/validation process may be updated periodically as new historical-performance data and other information about the institution become available.

The speed and reliability of such a dynamic simulator are founded on: 1) computerized replication of the institution's performance-driving feedback mechanisms; and 2) use of the institution's historical performance data as an independent benchmark for calibrating and validating that replication under the Scientific Method. These are synergistic: replicating the institution's feedback mechanisms makes it possible to reserve historical data as the calibration/validation benchmark; and calibration and validation under the Scientific Method reveal the strength and timing of the feedback mechanisms being simulated. Replication of feedback mechanisms sharply reduces required input data, which contributes to high analytical speed and reliability. For instance, when the dynamic simulator is properly set up and calibration and validation have been updated, thousands of scenario-based simulations of the institution's performance can be quickly conducted and may be reliable to within, e.g., five percentage points or less simultaneously on all significant measures of the institution's performance. That is, for any given scenario that is simulated, the results may indicate within, e.g., five or fewer percentage points how the institution will perform under that scenario.

Systemic Analysis in Support of Proactive Systemic Management.

The institution's calibrated simulator will usually have one or more of the following related purposes: 1) simulating the institution's systemic performance under a range of scenarios reflecting various management options, outside influences, and internal and external risk factors; 2) use of such simulations to better understand and anticipate the institution's performance under those scenario conditions; and 3) seeking out systemically effective combinations and sequences of management options that may yield sustainably superior institution performance in the face of risk factors.

Many modern institutions face a large number of: 1) management options, many of which can be combined to create hybrid options; 2) risk factors, which can also combine with each other; and 3) a resulting “combinatorial explosion” of combined option/risk scenarios. Each of those combined scenarios may uniquely influence the operations of the institution's feedback mechanisms and its resulting performance. The full array of such scenarios generates a very wide range of possible performance trajectories for the institution.

Absent dynamic simulation, the multiplicity of possible scenarios forces managers to focus on a very small subset of the relevant options and risks and to ignore the vast majority, with profound consequences for the institution's performance.
The management options selected for analysis will usually have a very low statistical likelihood of acting on high-leverage points in the feedback mechanisms driving the institution's performance;
The much larger number of options ignored will usually include some that would act favorably on those systemic high-leverage points and deliver sharply improved performance and sustainability;
The small set of evaluated risks is unlikely to include those that are systemically most relevant to the selected management options, and particularly unlikely to include risks that would act on systemic high-leverage points if they were to materialize—the latter tend to be the biggest threats to the institution's performance.

In the context of systemically driven performance, traditional approaches to the combinatorial explosion of options and risks may result in systemic sub-optimization of performance for many modern institutions. For instance, many institutions continually run well short of the performance they could generate with available resources, and are able to command and employ far fewer resources than potential performance would justify. Resulting performance and value losses are large, e.g., at least 20% in most such entities. Those losses directly threaten institutional sustainability.

There are three ways that systemic analysis and management can help reduce performance sub-optimization in modern institutions.
1) Systemic simulation-based analysis locates the “high-leverage” points in the institution's feedback mechanisms, points at which a management option or materialized risk will have a disproportionately large influence on the institution's performance. The speed of the simulation process supports comprehensive testing to reveal those high-leverage points and anticipate how they will shift under different scenarios. None of this is possible with traditional analysis methods.
2) Knowing the location of performance high-leverage points (which are generally not more than a small portion (e.g., less than about 5%) of all nodes in the institution's feedback mechanisms) can significantly reduce the number of management options and risk factors to be analyzed. Because most options and risks will not directly affect a systemic high-leverage point, they can be expected to produce only small differences in the institution's performance and can be accorded a lower analysis priority, freeing resources to concentrate on more highly leveraged analyses.
3) The speed of the simulation process allows systematic exploration of remaining high-leverage options and risks and combinations thereof. Exploration includes optimization, automatically searching for the best option combinations given risk factors to which the institution is exposed.

This process reliably reveals management choices for the institution that: a) are systemically synergistic option combinations rather than less effective single options; b) tend to produce robust performance in the face of the most important risk factors; c) would be very unlikely to emerge from non-systemic forms of analysis; and d) have the potential to produce sharp and sustainable performance improvements and substantial resulting gains in the institution's value.

Analysis for Sustainability.

Sustainability involves systemically coordinated management of one or more of the following three main facets: 1) the institution's performance; 1) the institution's development program and its performance consequences; and 3) investment funding for the development program. Being strongly interdependent, the interaction of two or more of these three elements may make the institution either sustainable or unsustainable depending on how they are managed. Traditional approaches have typically produced systemically uncoordinated initiatives on those three dimensions, resulting in sustainability problems. Systemic management makes feasibility possible on all three facets, and simulating their intersecting dynamics is relevant for systemically effective management.
1) Analyzing Performance Sustainability. Such analysis begins with the institution's present systemic structure (feedback mechanisms) and those of the systems with which it interacts—those determine the institution's present performance capabilities. The initial objectives of such analysis are to identify threats to near- and mid-term performance, develop and test mitigation options, develop and test ways other ways of improving institution performance, or a combination of any two or more of them—all without diminishing the institution's overall strength and longer-term performance capabilities. Such analysis may include risk-based dynamic optimization of the institution's management options. It includes the institution's interactions with other systems (government agencies, markets and competitors, populations, etc.) and influences from larger systems (economies, for example). Such analyses usually aim at improving near- to mid-term sustainability, reducing threats to sustainability, or both.

There have been many applications of dynamic simulation technology in many different types of institutions, generally aimed at addressing a particular issue or solving some specific performance problem—these have amply demonstrated the anticipatory and value-enhancement power of the technology. In many cases those applications ended once the triggering issue or problem had been addressed—neither the technology nor the capability to employ it were institutionalized in some way for ongoing application to other issues and problems. The method outlined here includes and involves continuous, ongoing application of dynamic simulation technology to enable continuous systemic proactive management and resulting performance improvements leading to sustainability.

The method described here also includes and involves dynamic analysis of the institution's performance to identify systemic high-leverage points under both present conditions and those that might prevail in future. Those high-leverage points are the focus for analysis of the most important potential threats to the institution's future performance, and of the most important opportunities for improving performance. Results of such analyses are used to specify guidelines for the institution's development program, which aims at bringing about those improvements and enhancing sustainability.
2) Analyzing the Institution's Development Initiatives. In complex modern institutions a development program that is consistent with sustainability may include multiple projects of different types. Those component projects should relate to each other in synergistic ways; in practice that may happen if development is sustainable for the institution. If it is not then development projects will tend to be fewer, occasional, narrow, and reactive, with little or no inter-project influence or interdependency. Then the institution may have a few isolated projects rather than an integrated development program, which simplifies project definition and management but it is not symptomatic of healthy sustainability.

When development is sustainable for the institution, projects are much more numerous and frequent and have more extensive temporal overlaps, they are more proactive in nature and have broader scope, and those differences substantially increase inter-project influence and interdependency. Whether or not those projects constitute a systemically effective development program depends on their level of integration—an effective program may be a system of complementary projects that do not interfere with each other dynamically. A poorly integrated or un-integrated set of projects is a collection rather than a system, and a dangerous one at that.
An urban example: it makes little sense and would damage metropolitan performance and attractiveness to invest in highway development projects to ease traffic flows into the city center without complementary projects to better manage that traffic when it arrives there.
A corporate example: it makes little sense and would damage business performance to invest in expanding manufacturing capacity if the sales force is too small or lacks the experience required to generate and sustain the targeted increase in volume. Such a situation calls for complementary projects to increase sales capability in tandem with manufacturing capacity.

These examples may seem obvious, but problems of this sort tend to be the systemic rule rather than the exception. The urban example is common to many cities, and unbalanced functional development is frequent in business. Mistakes like these are easy to make in the absence of integrated analysis capability across the whole of the institution's dynamic system and the other systems with which it interacts. The systemic performance consequences of such un-integrated development efforts can be devastating for the institution's sustainability, and yet go unrecognized. This is much more than just lack of foresight and demonstrates how hard it is (using traditional methods and tools): 1) to anticipate fully even the direct operational consequences of complex projects; and 2) to take proper account of those consequences in an integrated program of complementary projects, the whole of which is intended to be considerably greater, performance-wise, than the sum of its component parts.

For sustainability purposes the institution may systemically manage one or more of the following four interconnected dimensions of its development.
The dynamics of individual development projects. Each development project is a complex system in its own right and its feedback dynamics drive project performance on the three critical performance dimensions of cost, schedule, and delivered functionality. These constitute the direct operational consequences of the project for the institution. Complex projects are notorious for overrunning cost and schedule targets and for falling short of functionality targets—such failures are interconnected and usually systemic in nature, and they directly threaten sustainability of the institution. The prevalence of project-performance difficulties stems from the systemic limitations of traditional analysis and management methods. Systemic management may be employed to ensure that each development program contributes as planned to the institution's performance and sustainability.
The dynamics of the development program. A multi-project development program is a super-system comprised of individual projects that are themselves systems, and the connections and influences between those projects constitute the performance-driving dynamics of the development program. Inter-project influences can be technical or performance-based, as when a city pursues complementary projects to enhance highway capacity and city-center traffic-management. They can also be resource-based, as when multiple parallel development projects compete for scarce resources. Systemic management may be employed to ensure that the development program meets schedule and cost targets and delivers the planned functionality for the institution with maximum synergy and minimal losses from inter-project influences.
The short- & longer-term dynamics of the program's influence on the institution's performance. Development projects and programs are intended to favorably influence the institution's operational dynamics and those of its interactions with other systems, thereby improving long-term performance. But many plausible development-project candidates may turn out to have little beneficial effect on performance (e.g., because they don't influence the institution's systemic high-leverage points) and some may be found to damage it. Systemic analysis of the institution's performance-driving operational dynamics is useful to define a development program that has a high likelihood of improving performance despite associated uncertainties and risks.

The development program may also have transitional influences on the institution's performance, temporarily disrupting normal operational dynamics in ways that tend to hurt performance during project implementation. This “worse before better” phenomenon is itself dynamic—project-driven disruption tends to compound when multiple projects are carried out in parallel. Systemic management may be employed at the intersection of development-program dynamics with the institution's operational dynamics, simulating that interaction to ensure that transitional performance losses are small and short-lived and do not themselves threaten the development program and targeted performance gains.
The dynamic influence of institution performance on development-program results. Results from even the best-defined and best-managed development program can be diminished or defeated if the institution performs poorly or in ways that are inconsistent with that program. Bad performance may make it difficult to obtain needed development resources and can itself dynamically offset targeted benefits from the development program. Systemic management employing dynamic simulation is useful to ensure that actions and performance of the institution remain consistent with development-program objectives and requirements.

Dynamic simulation of individual development projects is not new, having been applied on hundreds of individual projects since the late 1970s. What is new, and relevant for sustainable institutions, is ongoing dynamic simulation enabling systemic management of the institution's entire development program on one or more of the following two levels:
a) In defining and testing multi-project programs: for synergistic performance benefits at the institutional level; to identify and mitigate disruption of the institution's operations by the development program; and to identify and mitigate potential interference between individual projects in the development program that may reduce delivery of performance benefits for the institution;
b) As in past single-project applications: to define and test individual development projects for cost-effective delivery of targeted benefits; and to identify and mitigate single-project risks that may result in overruns and reduced delivery of performance benefits for the institution.

In hundreds of applications, dynamic project-simulation technology has been consistent: in providing unusually reliable anticipation of cost/schedule/functionality performance and early warnings of problems; and in delivering substantial performance improvements in the face of the many risks involved in complex projects. Many traditional project- and program-management tools and methods are also useful, but they may be insufficient for the systemic proactive management of development initiatives relevant for sustainability.
3) Analyzing Funding Sustainability. The institution's development program, the institution's overall performance, and its development-program funding are highly interdependent. Sustainability of the institution depends on a sustainable development program made possible by sustainable funding for that program. Sustainable funding, in turn, depends on the institution itself being demonstrably sustainable.

Finance providers have traditionally assessed the sustainability of an institution based on backward-looking performance measures applied to the institution as a whole. This backward-looking approach has been necessary because traditional analysis methods often may be unable to reliably anticipate the future performance of an institution in the face of risk over the long time-spans associated with capital investments. Backward-looking finance methods may be insufficient to support the volume and nature of development needed for sustainable institutions.

Dynamic simulation technology has made it possible to reliably anticipate the performance of a complex institution and of its development program in the face of risk. That proven capability is the basis for a new form of financing based on reliable forward-looking measures of institutional performance coupled with proactive systemic management of the dynamics that drive returns on and the ultimate return of invested capital.

This new form of and approach to financing is a relevant part of the method outlined herein for ensuring the sustainability of modern institutions. It may significantly reduce and actively manage uncertainties and risk for institutions and finance providers, changing the availability, pricing, profitability, or a combination of any two or more of them, of financing for those institutions that demonstrate their ability to become and remain sustainable. Achievable and demonstrable sustainability is the basis for this new form of financing, and that financing plays an important role in modern institutions' achievement of sustainability. Sustainable finance is addressed in greater detail in the next section.

Complementary Traditional Analysis Methods.

Although they may be insufficient for sustainability purposes, many traditional analysis methods complement and inform the dynamic simulation analyses needed for proactive systemic management.
Engineering-style models assume that the behavior of the whole system model will be correct if all its component pieces are correctly represented, and that the technical characteristics of those pieces are straightforwardly knowable. Such models are common in applications as diverse as power-plant valuation and traffic analysis. They typically do not deal with social, economic, and other interdependencies which operate through non-technical feedback mechanisms, and so are insufficient to enable proactive systemic management and institutional sustainability. Dynamic simulators can and have incorporated elements of engineering-style models with the more comprehensive and integrative representations needed for proactive systemic management.
Econometric models are the backbone of traditional economic forecasting. They employ purely backward-looking mathematical techniques, using historical data series to populate equations. They become intractable very quickly if data on the elements of the real system are not abundant and high-equality. Every variable in an econometric model must be directly measured by numerical time-series data, which means that important but unmeasured economic and social phenomena must be excluded from econometric analysis. Consequently such models lack the comprehensive integration needed for proactive systemic management and so are insufficient to support the sustainability of institutions. Dynamic simulators can and have incorporated econometric results into their structure when it is feasible and appropriate to do so.
Financial and accounting models represent many elements and relationships that are important to the institution and to finance providers and other stakeholders. They typically rely on numerical inputs and make not attempt to replicate or simulate the feedback mechanisms that drive the systemic elements in question. Consequently they are necessary and very far from sufficient for proactive systemic management and sustainability. Dynamic simulators can and do connect to financial and accounting models or include portions of such models.
Agent-based models in theory capture all behaviors from the individual on up, for any length of time and for any scope of problem. In practice agent-based modeling and analysis of even moderately complex social and economic systems has not come close to its theoretical promise and is insufficient by itself to support proactive systemic management and institutional sustainability. But there are some applications (simulating the movements of crowds, for example) for which agent-based modeling is particularly effective, and dynamic simulators can and do incorporate agent-based representations, subsystems, or components when it is feasible and appropriate to do so.
Geographical Information Systems (GIS) and spatial dynamic modeling—GIS are widely used to manage and visualize spatial data in support of decision making GIS by itself is not normally predictive or dynamic, but may incorporate or link to spatial dynamic models that simulate the behavior of spatially distributed grid points or entities. Not all problems are geographic or spatial in nature, so GIS and spatial dynamic models address only a subset of relevant problems. However, where appropriate, dynamic simulators can and do incorporate geographic information and spatial dynamic representations, subsystems or components.
Discrete Event Simulations emphasize stocks and flows of quantized elements that change at discrete times, as in the simulation of production processes. These simulations are closely related to dynamic simulators, and differ primarily an aggregation and emphasis. Where appropriate, dynamic simulators often include events at discrete times and quantized variables.

### III. THE FUNDING FACET OF THE METHOD: SUSTAINABLE FINANCE

To understand Sustainable Finance it helps to begin with a traditional approach to financing.

Traditional Financing.

Capital financing is arranged and managed based at least in part on backward-looking measures of the institution's performance, such as one or more of the following backward-looking measures:
Trends in that institution's size or volume, share price (for corporations), revenues, cash flows, ratios of debt in proportion to equity or cash on hand, of debt service relative to cash flow, or other financial parameters, or a combination of any two or more of them;
The institution's history of returns on finance capital, return of that capital, or capital gains on that institution's financing, or a combination of any two or more of them.

Finance decisions are based on past data because traditional methods may be unable to reliably anticipate the future performance of most institutions, including the influences of development investments on performance. Referring to FIG. 11, in a traditional approach 1100 to financing, there is a finance-seeking institution 1102 (e.g., a corporation, government, or some other type of organization) and one or more finance providers 1104 (e.g., banks, insurers, pension funds, insurers, hedge funds, money-market funds, individual investors, or another type of finance provider) that provide investment decisions, capital flows, or both 1105 to the institution 1102.

Various experts (e.g., accountants, auditors, analysts, rating agencies, or other experts) examine and analyze past market and performance data 1108 regarding the institution 1102 and issue professional opinions 1110 which finance providers 1104 may employ to guide their decisions. Those decisions include, e.g., financing commitments, provision of capital, modifications of contractual terms on existing financing, purchase or sale of resulting finance assets, or other decisions, or a combination of any two or more of them. Data 1108 employed may include, e.g., financial performance measures for the institution, similar institutions, or both, at a summary level, with respect to specific past financings, or both. Efforts to anticipate the institution's 1102 future performance may combine short-term extrapolation of past data with sensitivity-testing of assumed differences about the future. Thus the traditional approach bases even anticipatory analyses mostly on past data 1108.

Finance providers 1104 seek returns 1112 on the capital 1105 they provide and, ultimately, the return 1112 of that capital. Returns on and of capital 1112 close a feedback mechanism 1114 that constitutes the institution's 1102 finance cycle. In that cycle: 1) near-term availability and cost of financing may influence the magnitude and pace of investment by the institution 1102; 2) after significant time lags the fruits of investment may shape the institution's 1102 performance trajectory and resulting returns on and return of finance capital 1112; and 3) returns on and of capital 1112 may influence subsequent availability and cost of financing 1105 to the institution 1102. Each component of that cycle 1114 is both cause and effect, reflecting and determining financing sustainability for finance seekers 1102 and providers 1104.

Financing may come in various forms and combinations of equity and debt which may dictate the nature of returns on and the return of invested capital.
Debt is issued based primarily on bond ratings, which are backward-looking assessments of borrower-specific or class-specific debt-service and capital-repayment risks. Lending terms may include covenants requiring the borrower to maintain specified performance ratios and allowing the lender to modify the lending terms (after the fact) if those covenants have been violated (as evidenced by backward-looking performance measures).
Equity financing is based primarily on past performance results. Institutional investors (who own most equities) base equity investment decisions heavily on stock-price trends and modified extrapolations of those trends, and on the market-capitalization percentages of economic sectors and individual firms within them. Such measures mostly reflect past performance.
Project finance (which can include both equity and debt) is sometimes employed to fund investment projects involving specific assets for which anticipated performance (volume, revenues, profits, etc.) is employed to secure the financing—with terms that are based substantially on past performance data from similar assets. The checkered history of project finance is partly due to the fallibility of such backward-looking views, and in general this approach is too specialized for use in more than a modest fraction of financing for modern institutions.

Traditional financing decisions may thus be decoupled from future performance of the institution in one or both of the following two ways: 1) by being based mostly on data about that institution's past performance or performance of similar institutions; and 2) by being mostly independent of how that institution will manage the rest of its finances and actions and how those will affect its future performance. Yet such disconnections from the future are primary determinants of true financing risks, which strongly influence how the finance cycle operates and resulting availability (sustainability) and price of financing for the institution.

In practice, traditional finance is significantly limited by the need for an existing and clearly separable revenue stream to secure financial returns, and by the expectation that the institution's future performance should be very much like its past and can be inferred from that past. Consequently it is effectively impossible for traditional, backward-looking finance to fund the constant development and change that are inherent in and essential to sustainability. Traditional forms of finance have a useful contribution to make but are quite insufficient to establish and support sustainable development and sustainable institutions.

Proactive Sustainable Finance.

Referring to FIG. 12, in contrast, a sustainable-finance approach 1200 is based on a proactive systemic management process employed continuously for all elements and at all stages of the finance cycle. Its basis is forward-looking risk-based dynamic analysis that rigorously connects financing decisions with the institution's 1102 funded development initiatives, their future performance consequences, the institution's 1102 overall performance in future, and subsequent returns on and of finance capital 1112. Forward-looking dynamic analysis demonstrates sustainability to the benefit of finance seekers 1102 and providers 1104 by ensuring one or more of the following: 1) steady flows of finance capital 1105 to the institution; 2) effective investment in a development program that reliably delivers performance improvements; 3) ongoing management decisions that enhance the institution's 1102 performance and insure and protect the gains from development; 4) capitalization of resulting gains to ensure attractive returns on and the return of capital; which 5) justify and attract continued flows of finance capital. Dynamic simulation technology and systemic management energize all elements and stages of the finance cycle so that it becomes self-sustaining—to the benefit of both the finance-seeking institution 1102 and finance providers 1104.

Where traditional finance is backward-looking and reactive, Sustainable Finance is forward-looking and proactively managed. The benefits of Sustainable Finance are individually significant and collectively synergistic and transformational for the institution 1102 and finance providers 1104 alike. Example benefits of Sustainable Finance may include one or more of the following:
Dynamically linking financing with the institution's investments and future performance may sharply reduce uncertainty and risk associated with returns on and the return of capital.
Dynamically based selection and implementation of investment projects may substantially increase resulting performance benefits for the institution, both by better targeting by avoiding overruns and reductions in project functionality. Reducing those risks benefits both the institution and finance providers.
Continuous dynamic risk-based performance forecasting and optimization by the institution may quantify and protect targeted performance gains, capitalization of those gains, or returns on and the return of finance capital, or a combination of any two or more of them.
For the institution 1102 Sustainable Finance may substantially increase the availability and affordability of financing and the volume and sustainability of development initiatives, helping to establish the institution on a sharply improved and sustainable performance trajectory.
For providers 1104 Sustainable Finance may greatly strengthen qualification of the institution and provides continuous forward-looking controls, significantly reducing financing risk and increasing the amount of finance capital that can be sustainably and profitably provided.

To summarize, Sustainable Finance is a major advance beyond the limitations of traditional backward-looking finance decision-making. By employing past performance data in very non-traditional ways made possible by dynamic simulation, it enables reliable forward-looking analysis and optimization which increase performance, reduce risk, and sustainably increase financing volume, effectiveness, and profitability.

Sustainable Finance Depends on Sustainability Assurance Capability.

Referring also to FIG. 13, the Sustainable Finance cycle 1100 centers on a new Sustainability Assurance Agent 1300 and capability made possible by dynamic simulation technology. Sustainability Assurance operates continuously in support of the institution 1102 and finance providers and their mutual interest in sustainable financing. Its purpose is forward-looking risk-based analysis and optimization of financing, investment, management options and option combinations, and returns on and the return of invested capital. The Sustainability Assurance agent 1300 provides proactive guidance 1232, 1234 to this end to the institution 1102, finance providers 1104, or both.

Sustainability Assurance draws on information from a variety of sources. For instance, example sources 1250 from the institution 1102 may include one or more of the following:
Data on the institution's past performance;
Information on the elements and connections that systemically define that institution and its operating environment and drive its performance;
Characterizations of strategic opportunities, risks, and threats;
Characterizations of investment and implementation options and option-specific risks;

Example sources 1252 from finance providers 1104 may include one or more of the following:
Characterizations of financing options and related terms and conditions;
Information on finance-market conditions, including risks.

Other example sources 1254 may include one or more of the following:
Relevant economic and market information;
Expertise regarding development options and their direct operating effects on the institution;
Expertise and capability in development-project and development-program management

The vehicle for Sustainability Assurance is the institution's dynamic simulator covering the institution 1102, its operating environment and development program 1302, and links to finance providers 1104. The validated simulator 1304 may be employed to guide both the institution and finance providers. This entails integrated proactive systemic analysis (including risk-based optimization) and management of finance, development, and institution-management options to support sustained flows of finance capital and returns on and the return of finance capital, all on an ongoing basis. The Sustainability Assurance capability includes one or more of the following dimensions and proactive systemic management of their influences on performance of the institution and its financing:
Strategic options and risks;
Investment/implementation options and their risks;
Financing options and their risks;
Specific investment projects, their risks, and schedule/cost/functionality performance;
Ongoing strategic and operational decisions by managers of the institution.

Dynamic analysis and optimization across these dimensions may reveal, in advance, option combinations which will act on systemic high-leverage points to substantially improve performance of the institution and institution financing. It may also reveal, in advance, plausible options and management decisions which would conflict with or undermine such improvements. The process is continuous, constantly addressing changing conditions that are brought about, in part, by the Sustainability Assurance process. The results are sustainable financing, enhanced performance, and reduced risk for the institution and finance providers alike.

Sustainability Assurance is made possible by dynamic simulation technology, which provides several critical capabilities not available from traditional methods.
The simulator can include the full range of elements and connections between elements that define the dynamic system which drives the institution's performance and returns on and return of invested capital.
The high speed of dynamic simulation allows analytical coverage of a much broader range of investment/financing option combinations and associated risks, and makes possible risk-based optimization of those options, protecting returns on and return of invested capital.
The simulator provides demonstrably reliable long-term scenario-based performance anticipation to match financing and investment timeframes.

Transitioning to Sustainable Finance.

The various forms of financing (debt, equity, project finance, etc.) have different characteristics and may contribute in different ways during the transition from traditional to Sustainable Finance.
Lenders (providers of debt financing) are often among the most conservative of investors, requesting or requiring the highest degree of certainty regarding returns on and return of capital and being least comfortable when the future performance of the finance-seeking institution is expected to be quite different from its past.
Equity investors may seek and accept significantly greater risk in the timing and rate of investment returns. Corporations supplying products, services, and expertise to the institution's development initiatives may make an associated equity investment to gain a greater voice in and return on the program.

Equity-method accounting requests or requires that shareholders have “significant influence” but not “control” over the entity in which they are investing. When the finance-seeking institution is a government body, the investment vehicle might be an incorporated development authority set up by that government; when the finance-seeking entity is a corporation the investment vehicle might be an incorporated joint venture. Shareholders may be quite diverse, including, e.g., suppliers participating in the institution's development program, contractors, providers of services and professional expertise to the institution, the finance-seeking entity itself, or other shareholders. As the development program proceeds and the institution's performance improves as targeted, original shareholders can sell to successors and the investment vehicle can take on debt, arrange operating leases and sale/leaseback arrangements, etc. Returns to equity investors and lenders can be via any of the well-established mechanisms associated with traditional financing. The institution's simulation-based Steering Platform may give investors a continuous forward view of future prospects and performance offering unique visibility and reliability.

Complementary Forms of Organization.

Investment vehicles come in many different forms with different strengths and limitations, and most of them can be compatible and add value in conjunction with Sustainable Finance. For instance, example approaches to organization may include one or more of the following:
The institution as integrator. A government institution may charge one or more of its departments with development responsibility. This approach can be strongest where the tasks involved are repetitive and primarily administrative and can be less appropriate when specialized capabilities or a mission different from those in government are involved.
Independent agencies and joint ventures. Governments often form agencies to deal with specific functions that can by themselves generate revenues for ongoing operations and development. Corporations sometimes form joint ventures, where two or more corporations contribute people and startup funding, in return for a hoped-for stream of profits from the joint venture's performance. Agencies and joint ventures can be appropriate where ongoing financing does not depend on outside sources, and outside capabilities are relatively commoditized. The scope of their decision-making authority must be carefully specified, and their organizational boundaries can become barriers to the sort of integrated action necessary in proactive systemic management.
Public-Private Partnerships (PPP). In a sense PPPs are an evolution of agencies and joint ventures, with particular arrangements for operations and finance on the Private side based on performance metrics reflecting public needs and objectives. These can and have been quite successful. Their structure tends to lock financing sources together with the operating organization, consequently they can most easily be set up where sources of revenue are distinct, close to operations, and sufficient to finance operations. Where that is not the case, PPPs may not be feasible or successful. Performance of the PPP depends on many actions of the public side of the partnership, making up-front investment potentially inherently risky. Limitations of traditional analyses and performance measurements may be an even bigger threat, and one that can mostly be eliminated by enhanced visibility and reliability brought by dynamic simulation.

### IV. HOW THE METHOD WORKS

Referring to FIG. 14, the following hypothetical case 1400 shows how a currently unsustainable institution (a large city 1402 in this case) arrives at sustainable performance, development, and financing by employing the method outlined herein.

The City and its Situation.

The institution is a large mature city 1402 in a developed country. It has been several decades since the city 1402 last experienced significant growth, since then employment and population have been in slow decline. Referring also to FIG. 15, this decline can be seen in simulations 1500 of historical city data (prior to the year 2010) for population, jobs, unemployment rate, assessed value, revenue, operational expenditures, and metropolitan debt. Population has also shifted from the city center to near-by suburbs as rising taxes 1410 and declining quality of services 1406 encouraged out-migration of both population and jobs. There is a great deal of metropolitan infrastructure 1408 (e.g., road and public transit networks, power generation and distribution systems, water and sewer systems, airport, schools, public and private buildings, or other forms of infrastructure, or a combination of any two or more of them) and associated services 1406, much of it provided by city government 1404 and the rest by quasi-governmental organizations and private corporations 1414.

Despite the absence of metropolitan growth, demographic shifts, aging systems, and cost-cutting have increased the load on infrastructure 1408 and services 1406. Funding for development projects has been in short supply due to: i) substantial accumulated debt and unfunded liabilities; and ii) poor fiscal conditions resulting from costs that have risen faster than increases in tax rates and fees. Projects to develop new infrastructure 1408 have been rare and isolated, with a history of cost and schedule overruns and under-delivery of planned functionality. Most investment has been to maintain or upgrade existing infrastructure 1408, but funding has not kept up with the rate of aging. As a result the condition and adequacy of infrastructure 1408 and associated services 1406 have declined in the face of shifting city 1402 demographics and needs.

City politics have been difficult regardless of the party in power. With operational and investment funding in short supply, neighborhoods and departments of city government 1404 compete with their counterparts for scarce resources, and citizens protest the rising cost of public and private services 1406. With little economic growth to build on, new projects and services 1406 threaten to interfere with or reduce funding for other metropolitan areas or activities. Resulting political opposition has tended to create gridlock which delays or prevents metropolitan development projects.

Due to decades of funding shortages and political difficulties, it has been a long time since the city 1402 last prepared a comprehensive long-term development plan for metropolitan infrastructure 1408 and services 1406. Planning has become mostly reactive, responding in piecemeal fashion to the most urgent problems of existing infrastructure 1408 and services 1406. Politicians, city managers, and citizens have all grown accustomed to “making do” with low levels of investment funding and development—much lower than an objective analysis would show to be needed.

In short, past decisions and performance have gradually pushed the city 1402 into a constrained and limiting corner of its performance envelope. As the city's 1402 balance sheet and fiscal performance deteriorated, finance providers 1424 limited their risk by reducing investment funding. No one can see any traditional way out of this condition, as can be seen from the results of simulations 1500 in which current performance is extrapolated into the future (e.g., as lines 1502a, 1502a, 1506a, 1508a, 1510a, 1514a, 1516a, 1518a, 1520a, 1522a, 1524a, 1526a, 1528a, 1530a, 1532a in the plots of population, jobs, unemployment rate, housing density, quality of life, ease of commuting, per-capita taxes, GMP per capita, energy use, emissions, investment ratio, assessed value, revenue, operational expenses, operational adequacy, and metropolitan debt, respectively).

Step 1 of the Method: Seeing the City as a System.

Referring also to FIG. 16, metropolitan leaders 1404 meet and begin working with experts 1414 in complex dynamic systems and sustainable development. Their first discussions are informed by a Metropolitan Steering Platform Demonstrator (MSPD) 1416 (e.g., implemented on a computer 1418) with a dynamic city-simulator 1420 as its analytical engine, provided and operated by the systems experts. That simulator 1420 is set up to reproduce the systemic structure and performance of a different city 1422, selected as an example because its challenges are broadly similar to those of the city 1402 (1600).

The MSPD 1416 enables city leaders to see, for the first time, the operation of the feedback mechanisms that drive metropolitan performance. It shows how those mechanisms, which include the actions of finance-providers 1424, have trapped the example city 1422 in a state of stagnation and decline. Although it is a demonstration tool rather than a definitive steering platform, the MSPD 1416 independently reproduces the recent history of the example city 1422—an important demonstration of validity (1602).

Together City leaders 1404 and sustainability experts use the MSPD 1416 to explore the sensitivity of metropolitan performance (including Quality of Life) to development programs aimed at revitalizing economic health, reducing energy consumption and greenhouse gas emissions, and establishing sustainable development (1604). Five investment-program options bring new metropolitan infrastructure 1408 and services 1406 along with new funding for their development:
Basic Infrastructure—traditional roads, water & sewer systems, etc.;
New Mobility—metros, light rail, electromobility, advanced traffic and parking data/controls/pricing/optimization, etc.
Low-Tech Building Upgrades—insulation, lighting/heating efficiency
Building Technologies—Building automation, advanced energy efficiency, self-generation
Smart Grid—intelligent IT/electrical/communications networks, energy automation, electrification, demand-response, dynamic load management, support for renewable/decentralized generation, microgrid control

Individually, each development option can potentially alter the example city's 1422 situation and performance—and some option combinations are technically synergistic. Smart Grid, for example, makes Building Technologies more effective—and vice versa.

In this exploration the MSPD 1416 is used to simulate a variety of alternative futures for the example city 1422 based on alternative development scenarios (1606). The first such scenario represents Business as Usual (BAU) for the example city 1422—investment and development confined to traditional forms of infrastructure 1408 and services 1406. The BAU simulation is the benchmark for determining how example-city 1422 performance would change as a result of alternative development programs that bring new forms of infrastructure 1408, services 1406 and new financing. Each of those alternative scenarios includes a different combination of alternative development investments, and each is the basis for a new simulation using the MSPD 1416.

Simulating those alternative development scenarios reveals strongly non-linear performance results for the example city 1422—a phenomenon typical of complex dynamic systems (such as cities) that is reliably revealed only through simulating those dynamics (1608). At one end of the non-linear performance spectrum lies a surprise—many of the above-listed infrastructure 1408 investments actually make example-city 1422 performance worse rather than better. When simulated using the MSPD 1416 these investments result in sharply higher metropolitan debt and taxes 1410, continued declines in jobs, lower Gross Metropolitan Product (GMP), and faster-rising unemployment. Although some dimensions of example-city 1422 performance improve (commuting becomes easier, energy use and emissions are reduced, property valuations increase and overall Quality of Life stabilizes), none of these infrastructure 1408 investment combinations makes the example city 1422 more sustainable in its economics, finance, or development. It portrays a city 1422 very much in decline but with increased debt, fewer jobs, and less income.

That result is surprising to city leaders 1404 because it is counterintuitive—how is it possible that developing attractive and obviously beneficial infrastructure 1408 can make the example city 1422 worse off and less sustainable? The answer lies in the fact that the city 1422 is a complex dynamic system in which new infrastructure 1408 developments energize pre-existing feedback mechanisms, some of which can dynamically offset the beneficial effects of those initiatives (increased debt and taxation, for example). Unless new development programs are designed to favorably influence the small number of dynamic high-leverage points in the city-system, the offsetting effects will tend to dominate and the development is unlikely to generate the economic gains needed to recover invested funds. In a broader sense that isn't so surprising—the same dynamic has driven the example city's 1422 decline and resulting loss of sustainability.

But the MSPD 1416 simulations also demonstrate that other example-city 1422 outcomes are possible. One scenario in particular produces surprisingly positive results by combining a new and much larger investment initiative in Basic Infrastructure with Systemic Management of the city 1422 and the infrastructure 1408 projects. This combination stabilizes metropolitan population, sharply reduces the rate of job decline, lowers unemployment and taxation, and noticeably increases Quality of Life. Not everything is better under this scenario—GMP still declines (though at a slower rate) and energy consumption and emissions are sharply higher. But metropolitan debt is only a little higher than in the BAU scenario and the city 1422 is healthier on many fronts—still declining but more slowly than in the BAU scenario.

That outcome also surprises city leaders 1404 because (as described above) simulating investment in Basic Infrastructure alone made the example city 1422 noticeably worse off. It appears that investing simultaneously in Systemic Management and Basic Infrastructure is synergistic in some unexpected way, causing the performance consequences of Basic Infrastructure investment to shift from negative to positive. City leaders 1404 want to know what Systemic Management is and what makes it synergistic.

For the example city 1422 Systemic Management means using a definitive Metropolitan Steering Platform (MSP) 1423 to understand and better manage the dynamics of: 1) metropolitan operations; 2) new infrastructure 1408 investments; and 3) metropolitan land use (the residential/business mix). In practical terms it means managing the example city 1422 and its investment programs holistically, as complex systems, which is made possible by the same simulation technology that is employed in the MSPD 1416.
1) Using dynamic simulation to guide operational refinements in complex dynamic systems (cities, corporations) consistently produces efficiency gains of 10% or more.
2) Using dynamic simulation to manage complex development programs and their component projects has proven to increase efficiency in several ways:
   a. Better project selection, definition, siting, etc. to optimize beneficial consequences for metropolitan performance and Quality of Life (minimum 10% efficiency gains, often much more);
   b. Better implementation of multiple development projects—sequencing, pacing, resourcing, etc.—reducing conflicts and under-resourcing (minimum 10% gains, often much more);
   c. Reduced cost/schedule overruns and increased delivered functionality on individual projects through improved risk management, early warning of developing problems, and rapid identification of systemically effective solutions (minimum 10% gains, often much more).
3) MSP 1423 analyses typically reveal shifts in land-use policy (the mix of residential, commercial, and other land uses) that will favorably influence the ratio of metropolitan jobs to population.

The MSPD 1416 simulation demonstrates that Systemic Management and a substantial Basic Infrastructure development program are dynamically synergistic for the example city 1422.
First it shows that investing in Basic Infrastructure development alone would accelerate example-city 1422 decline (as described above);
The MSPD 1416 also shows that investing in Systemic Management alone would marginally improve example-city 1422 performance, but not enough to stop the decline in jobs, population, GMP, and Quality of Life;
Finally the MSPD 1416 demonstrates that together these two investments are systemically synergistic, stabilizing the example city 1422 and improving performance on most measures.

This is like summing −1 (the effect of Basic Infrastructure development alone) and +1 (the effects of investing in Systemic Management alone) and finding the answer to be +2—a counterintuitive result that is typical of dynamically complex systems such as the example city 1422. The combined effect of these investments, being systemically or dynamically greater than the sum of the parts, produces an unexpected non-linear change in metropolitan performance. Systemic non-linearity's are one key to establishing sustainable development, and Dynamic simulation (the technology engine of the MSPD 1416) is essential to finding and exploiting such non-linearity.

Now the city leaders 1404 want to see whether it's possible to take further advantage on this non-linearity in example-city 1422 performance. Using the MSPD 1416, and working from the starting point of Basic Infrastructure development+Systemic Management, they begin adding in other forms of infrastructure 1408 development and associated financing. To their surprise, the same development options that made the example city 1422 worse off in previously simulated scenarios now create significant performance gains.
New Mobility infrastructure development boosts jobs and population, halting unemployment growth and increasing metropolitan GMP per capita.
Building Technologies, Smart Grid, and Lo-Tech Building Enhancement development programs all contribute to 50% reductions in energy use and emissions. Without them energy use and emissions would be driven sharply higher by economic growth.
Smart Grid development noticeably increases per-capita GMP in the example city 1422, but that gain is substantially offset by GMP reductions resulting from Lo-Tech Building Enhancement and Building Technologies development (because they cause metropolitan debt and taxation to increase). As a result metropolitan GMP per capita is still falling, though at a slower rate than previously.

At this point the MSPD 1416 shows the example city's 1422 development investment running at 4-5 times its BAU rate, with clearly beneficial consequences—although debt is substantially higher, increased population and jobs are generating higher city revenues and taxation is slightly lower. What is more, overall Quality of Life is much higher.

By comparison, in the absence of Systemic Management, the MSPD 1416 showed that this same combination of development programs and level of investment would make the example city 1422 economically and financially worse off and less sustainable. The unavoidable conclusion is that the performance consequences of infrastructure 1408 development programs are determined more by dynamic synergies (with Systemic Management in this case) than by the specifics of those development programs. Such synergies can be found and reliably exploited only by simulating the metropolitan dynamics that drive them.

At this point the example city 1422 is doing so much better financially that potentially complementary policy initiatives become worth considering. Additional simulations with the MSPD 1416 demonstrate that the above-described gains can be increased by:
Shifting the land-use mix somewhat more towards business and away from residential use (a policy initially implemented as part of Systemic Management), which sharply reduces unemployment and lowers associated metropolitan operating costs; and
Increasing taxation to stabilize example-city 1422 debt (which rises rapidly otherwise)—that also ends rising per-capita taxation, stabilizing it at a noticeably lower level than the example city 1422 would have attained otherwise.

The MSPD 1416 shows that the example city 1422 is transformed by this combination of i) broad infrastructure 1408 development; ii) Systemic Management; and iii) changes in land-use and taxation/debt policies. This can be seen from the graphed results of the MSPD 1416 analysis, e.g., lines 1502b, 1504b, 1506b, 1508b, 1510b, 1514b, 1514b, 1516b, 1518b, 1520b, 1522b, 1524b, 1526b, 1528b, 1530b, 1532b in the plots of population, jobs, unemployment rate, housing density, quality of life, ease of commuting, per-capita taxes, GMP per capita, energy use, emissions, investment ratio, assessed value, revenue, operational expenses, operational adequacy, and metropolitan debt, respectively.
Employment and population are stable or slightly rising (instead of declining), and unemployment is low and stable (instead of high and increasing);
Per-capita GMP is much higher and rising (instead of declining), whereas metropolitan debt and taxation are stable (instead of rising continuously) and taxation is noticeably lower;
Property values are up sharply, and energy consumption and emissions are substantially lower and stable despite significantly increased population and employment;
Example-city 1422 revenues are up (and stable) and operational expenditures down (and stable), enabling ongoing new-infrastructure 1408 development to continue at a level about three times that of the BAU scenario—without increasing example-city 1422 debt or taxation.

With stable population, employment, investment and infrastructure 1408 development, debt and taxation, energy consumption and emissions, and with high and stable Quality of Life and per-capita GMP, the MSPD 1416 has revealed that the example city 1422 can achieve sustainable development and much higher Quality of Life despite its poor initial condition and performance.

The MSPD 1416 simulations have also demonstrated that achieving sustainability and improved performance does not take a long time. Several important example-city 1422 performance metrics improve sharply in the first 2-3 years of the new initiatives (ease of commuting, energy consumption and emissions, property values, example-city 1422 revenues and operating expenditures, and overall Quality of Life). Other metrics begin to improve sharply around year four (metropolitan debt, per-capita GMP and taxation, and unemployment. By years 5-6 metropolitan jobs and population are noticeable increased as well. This shows that systemically effective initiatives can rapidly produce large performance changes and “quick wins” to support continuation of those initiatives. This demonstrates the power of dynamic simulation to show reliably where and when the first performance gains will come and how large they should be, along with the magnitude and timing of subsequent gains. These are important inputs to the political process through which new initiatives are launched and sustained.

The city leaders 1404 conduct one final MSPD 1416 experiment, going back to the example city's 1422 starting conditions and making the same land-use and taxation policy changes—but this time without any new infrastructure 1408 development or Systemic Management. The change in taxation policy succeeds in sharply reducing example-city 1422 debt, but that is the only noticeable gain—jobs, population, per-capita GMP and Quality of Life all continue to decline, and debt, taxation and unemployment continue to rise. This demonstrates that the effectiveness of the example city's 1422 land-use and taxation policy changes depends on first making that city 1422 sufficiently attractive to draw jobs and population—another example of non-linear systemic performance and its influence on the success or failure of new initiatives.

Step 2 of the Method: A Tailored Demonstration Capability for the City 1402.

City leaders 1404 are now interested in obtaining a dynamic simulator 1420 of their own city 1402, one that properly reflects its unique situation, resources, and objectives. They enquire of the dynamic-simulation experts how a definitive simulator 1420 of their own city 1402, suitable for detailed analysis and policy design, would differ from the example-city 1422 MSPD 1416 with which they have been working. A definitive MSP 1423 of the city 1402:
Would be much larger than the demonstration-level MSPD 1416, simulating in greater detail on multiple dimensions—for example:
   The performance of individual city-government departments (police, schools, sanitation, etc.) as well as public and private suppliers of primary metropolitan services 1406 (power, water and sewer, transport, etc.)
   Population demographics (ages, education and skill levels, income levels, and their geographic dispersion);
   Business and commercial demographics (industrial, commercial, retail, service, and their geographic dispersion);
   Individual regions/neighborhoods within and around the city 1402 and their characteristics (population, quantity and mix of residential and business buildings, property values, employment/unemployment, crime, etc.)
   Metropolitan revenue and cost line items, assets, and liabilities including individual financing tranches and their terms.
Would require a considerably larger volume of recent metropolitan data in greater detail, both as inputs to the MSP 1423 and providing independent historical-performance benchmarks for simulator 1420 calibration;
Would involve a great deal more collaborative effort to set up, validate, and employ (by the city and by simulation and other experts), and proportionately greater cost and calendar time (14-18 months to set up and validate);
Would provide highly reliable analyses and scenario-based forecasts of metropolitan conditions and performance (to within five percentage points).

In contrast, a tailored demonstration-level MSPD 1416 of the city 1402 would employ a small amount of readily available city data and could be set up and validated in about four months and with much lower costs. A tailored MSPD 1416 would also serve a different purpose, providing indicative and illustrative analyses for understanding and communication purposes, rather than definitive and detailed analyses supporting specific investment and management decisions and the design and implementation of new metropolitan initiatives.

City leaders 1404 decide to begin with a tailored demonstration-level MSPD 1416 and use its capabilities to build understanding of and support for initiatives aimed at achieving developmental, economic, and environmental sustainability (1610). They provide the necessary data, which the simulation experts employ in tailoring the MSPD 1416 to represent the city 1402. They input some data to the simulator 1420 to represent the different starting conditions in that city, and employ recent city-performance data as the benchmark for calibrating and validating the MSPD 1416 (1612). When that process is complete, the simulator 1420 independently replicates the last 8 years of history for the city on several key performance measures (employment, population, unemployment, city revenues, operating expenditures, and debt).

Once the MSPD 1416 has been tailored to reflect conditions in the city 1402, city leaders 1404 and simulation experts use it to conduct a round of scenario-based development experiments similar those described above for the example city 1422 (1614). The specifics of the scenarios and results differ, of course, being for a different city 1402, but the broad outcomes and conclusions are similar (1616):
Infrastructure 1408 development programs, by themselves, would not generate performance gains commensurate with their costs, increasing debt and taxation and reducing employment and population, thereby adding to the city's 1402 sustainability problems;
Systemic Management, combined with a Basic Infrastructure and New Mobility development programs, would improve metropolitan attractiveness and performance enough to stabilize population and jobs and reduce unemployment—but even without metropolitan growth, energy consumption and emissions would increase sharply;
That significant improvement in the city's 1402 situation would also change the consequences of investing in Smart Grid, Lo-Tech Building Enhancement, and Building Technologies development. Instead of damaging metropolitan performance, these investments would create modest job and population growth while sharply reducing energy consumption and emissions and increasing Quality of Life, all without changing taxation levels.
Having made the itself considerably more attractive, the city 1402 can further grow jobs and employment by providing more land for businesses and allowing housing density to rise. Going further on this element of Systemic Management will trigger a sharp reduction in unemployment and an associated reduction in city 1402 operating expenditures, accompanied by a turn-around and substantial increase in per-capita GMP.
The final transformational step for the city 1402 is then an increase in taxation to pay down debt. Not only would that stop the growth of metropolitan debt, but the increase in per-capita taxes 1410 would be small and short-lived. In less than 5 years per-capita taxation would also stop increasing (because city debt would no longer be rising). From that point on, being constant, per-capita taxes 1410 enjoy an ever-increasing advantage over the constantly rising taxes 1410 that would result with perpetually rising metropolitan debt.

For the city 1402 these simulations demonstrate that: 1) restoration of economic growth (through rising jobs, employment, and productivity) is essential for metropolitan sustainability; 2) growth, when systemically managed, enables the city 1402 to become sustainable environmentally and in Quality-of-Life terms; and 3) the city 1402 can then sustain investment funding and development at 4-5 times their previous rates without increasing debt and taxation.

Step 3 of the Method: A Dialogue with Finance Providers.

City leaders 1404 immediately see the significance of this unexpected outcome—not only that their city 1402 can be a great deal better off, but that past and future finance-providers 1424 will benefit as well because systemically managed resumption of development funding will so sharply improve metropolitan performance that financing risk will decline significantly. Infrastructure suppliers and service suppliers will also benefit based on a several-fold increase in funding for such activities. Based on these insights they begin a dialogue with finance-providers 1424 about funding for new infrastructure 1408 development programs to achieve metropolitan sustainability (1618). They use their tailored MSPD 1416: i) to demonstrate how combining development and Systemic Management can transform the city's 1402 fiscal performance and balance sheet; and ii) to discuss how a definitive MSP 1423 can be used to proactively manage the full development-funding cycle, thereby reducing financing uncertainty and risk. City leaders 1404 include auditors and rating agencies in these discussions because finance providers 1424 rely on them for help in assessing risk and reaching financing decisions.

Providers 1424 are generally intrigued by this new approach to managing metropolitan funding and development. Because of its long-standing problems and fiscal challenges, they had not considered the city 1402 to be a qualified candidate for new funding. Now, with the prospect of sharply improved performance and finances combined with a new and potentially superior approach to finance risk management, providers 1424 begin to reconsider. They focus on three questions: 1) how will the new approach work in practice; 2) how to ensure that metropolitan performance can be turned around and the city 1402 made sustainable; and 3) given the inevitable uncertainties, how confident can we be of reduced risk and appropriate returns on invested capital?

City leaders 1404 and their advisors explain how the approach will work in practice.
This city 1402 can't be sustainable unless its development and the investment funding that fuels development are also sustainable. That works in both directions—investment funding and development can't be sustained if the city's 1402 economy and fiscal balance are not sustainable. And if economics, fiscal balance, investment funding, and development aren't sustainable, the metropolitan environment and quality of life won't be sustainable either—in which case we're unlikely to generate the economic growth needed for overall sustainability. Sustainability on any one dimension depends on all the other dimensions of sustainability—in other words, sustainability is systemic.
In the past this city 1402 wasn't managed sustainably because no one had the means to manage systemically. Consequently, due to their interdependence, all dimensions of our metropolitan sustainability have spiraled slowly down together. The good news: our MSPD 1416 shows that we can reverse the direction of that systemic spiral, that the right early moves toward sustainability can drive a self-reinforcing “virtuous circle” in which progress on individual sustainability dimensions enhances sustainability on the other dimensions. The MSPD 1416 demonstrates that by initiating and managing that process systemically our city 1402 can become a sustainability-generating engine in which performance gains pay for themselves as we go. These dynamic analyses even give a good preliminary indication of a sequence of investments and policy changes that can make it happen.
It's clearly to everyone's benefit—citizens, businesses, finance providers 1424, and the city itself 1402—for this city 1402 and its funding and development to become sustainable. The question is: how can we begin and then sustain a collective march toward that objective? Our answer is to start with the four elements that propel the circular flow of sustainable investment funding:
   1) The selection, definition, and funding of infrastructure- and service-development projects that will improve metropolitan life and performance;
   2) The planning, resourcing, and execution of those projects to deliver targeted improvements with minimal cost and schedule overruns;
   3) City services 1406, operations, personnel, costs, revenues, cash flows, debt and other long-term liabilities, fiscal balance, and financial ratings;
   4) Returns on and the return of capital to finance providers 1424, from operational cash flows and new financing.
Obviously the flow of investment financing will slow or stop when one or more of these elements become problematic—our city 1402 has struggled with the first three elements and investment financing has been restricted as a result. We struggled because we had no way to properly manage all the systemic pieces, which resulted in: i) development projects that were poorly selected and managed, overran budgets, and failed to produce performance gains in proportion to their costs; ii) declining metropolitan quality of life and attractiveness, accompanied by declining jobs and rising unemployment; iii) city management policies and decisions that were inconsistent with a shrinking metropolitan economy and revenues, resulting in a bad fiscal balance and rising debt and taxes 1410; and iv) restrictions on investment funding to limit finance-providers' exposure to metropolitan risks.
We're in a different situation today because we have a platform that will help us reverse that downward spiral, making this city 1402 once again a safe and attractive partner for finance providers.
   You see the preliminary version of that technical platform in the MSPD 1416, in the dynamic city-simulator 1420 that is its analytical engine. This technology builds on traditional analysis methods and goes well beyond them in terms of capability and reliability;
   With the full MSP (Metropolitan Steering Platform) 1423, tailored to this city 1402, we can reliably advance-test candidate investment projects, singly and in combinations, to know how they will influence all dimensions of city 1402 performance and quality of life;
   With the MSP 1423 we can proactively manage the implementation and conduct of selected projects to maximize delivery of benefits and minimize overruns—this use of the simulation technology has delivered major performance gains in numerous applications;
   We will also use the MSP 1423 to monitor and manage city policies, decisions, operations, fiscal performance, and debt to guarantee returns on and the return of investment capital even in the face of economic and other uncertainties—similar applications have significantly enhanced performance while reducing risk.
The analysis and forecasting capabilities of the MSP 1423 also enables an important institutional advance that will play a critical role in making this city 1402 sustainable on all dimensions. In collaboration with finance providers 1424 we plan to establish a Metropolitan Sustainability Assurance Agent (MSAA) 1428 to play an essential leading role in the design, monitoring, and safeguarding of our city's 1402 transition to sustainability (1620).
   Purpose: The MSAA 1428 will be an independent and objective body accessible to and serving the sustainability interests of the city 1402, finance providers, and many other stakeholder groups.
   Responsibility: The MSAA 1428 will analyze, forecast, design, measure, advise, coordinate, and report on the initiatives, policy changes, investments, and funding required to achieve and maintain sustainability of the city 1402 and its financing and development.
   Role: The MSAA 1428 will be a watch-dog for all of us who have an interest in making this city 1402 sustainable. It will tell us about the options for achieving sustainability and recommend the best of those options. The MSAA 1428 will warn us of events and conditions that might threaten our transition to sustainability, and tell us how to avoid or mitigate the danger. It will particularly warn us if our own resources, policies, and decisions become threats to sustainability.
   Focus and Approach: The MSAA 1428 will be integrative: i) reflecting the connectivity and interdependency of the many elements that comprise the city-system; and ii) bringing together the organizations, bodies of knowledge, capabilities, and information required to achieve and maintain sustainability of the city 1402 and its development and financing.
   Resources: The MSAA 1428 will include applications experts in the gathering and processing of information, complex-project management and organizational change management, metropolitan dynamics and dynamic analysis, accounting and financial analysis, audit, risk analysis, and financial ratings.
   Enabling Technology: The MSAA 1428 will employ a wide variety of traditional analysis and forecasting techniques in conjunction with a validated Metropolitan Steering Platform (MSP) 1423 utilizing dynamic simulation technology. The MSP 1423 will simulate in detail the full range of city elements and connections between them, including development programs and financing, and will serve as the main analytical and forecasting platform in support of the city's 1402 sustainability efforts. Without the MSP 1423 technology the MSAA would not be able to make its sustainability-assurance contribution.
   The MSAA 1428 is one key to making this city 1402 sustainable again because sustainability is a system-level phenomenon that requires systemic management. No existing organization has the requisite capability—to make available to the city 1402 and its stakeholders 1426 the systemic information, understanding, analysis, and management support needed for metropolitan sustainability. The MSAA will set up and employ the MSP 1423 and make it accessible to the city 1402, finance-providers 1424, and other stakeholders 1426 as a platform for evaluating and managing ideas, policies, and initiatives that will make us sustainable again. We will all benefit by setting up this new, independent organization to provide those capabilities on a neutral and objective basis.
   As to the metropolitan turnaround and the prospect of achieving sustainability, proof that it's possible starts but does not end with the MSPD 1416. The next confirmatory step is the full, definitive Metropolitan Steering Platform, the MSP 1423. Its design represents the city 1402 in much greater detail—neighborhoods, types of infrastructure 1408, population and business demographics, public and private services 1406, and so on. That greater representational detail allows much more detailed and definitive analyses of development and management options, and of the risks involved—compared to the much simpler MSPD 1416, which is not intended for risk analysis. We will use the MSP 1423 to design a low-risk, systemically effective development program for improving the city's 1402 performance, and policy changes (such as increased business zoning to attract jobs) that will begin to make us more sustainable while the development program is being implemented.
   This is a long-term approach for achieving sustainability, a marathon rather than a sprint, because that's the sort of effort that the MSP 1423 will show can be sustained by the city 1402. The plan will be implemented in steps and each step will further demonstrate its feasibility. We will use the MSP 1423 continuously throughout the transformation process to monitor progress against our development and city-performance targets, to get early warnings and diagnoses of possible problems, and to find ways of mitigating those problems and optimize performance. This is not a ‘fire and forget’ procedure—it is continuous, reliably proactive, and fully systemic, and the simulation technology allows much more thorough and reliable exploration of the options and risks. Those options will be selected for their synergies, and their definition and implementation will be advance-tested for effectiveness using the MSP 1223. We never before had the means to demonstrate such things in advance, or to conduct a synergistic program in truly integrated fashion
   We will also use the MSP 1423 to monitor and control these initiatives and their progress and resulting performance gains, all on a real-time basis. The MSP 1423 will warn of potential problems far earlier than our old methods, giving us a lot more time to test solutions and a much higher likelihood of keeping the program and the turnaround on track. And the MSP 1423 will also be the instrument for designing and testing those solutions prior to their implementation. This is what we mean by proactive systemic management, and that is what makes the city's turnaround feasible and will ensure that it is being achieved. The city and its finance providers have never before had such reliable and transparent information or such comprehensive control, and these make us confident in the turnaround.
   Feasibility of the turnaround and achieving sustainability also depend on politics, and the MSP 1423 will be a big help in building consensus and a supporting coalition for the changes that will be required. We're already making the MSPD 1416 available to all city stakeholders, to create transparency and understanding about the challenges and what can be accomplished, and to involve stakeholders directly in designing and evaluating changes to the city 1402. We will do the same thing with the MSP 1423 when it's ready, making it available to everyone. So if someone believes their neighborhood will be adversely affected by the city's 1402 development program, they can evaluate the consequences themselves, at the local level, based on measures of neighborhood characteristics and quality of life. If they don't like the results, they can propose and test development-program changes aimed at improving things, or other measures to mitigate the consequences of development. The MSP 1423 will provide unprecedented access to and transparency of the political process, which will do a lot to improve the dialogue and avoid gridlock.

Proactive systemic management of city finance is a new capability that will simultaneously reduce risk and improve returns for finance providers. It makes finance forward-looking and proactively controlled, with big benefits over the traditional backward-looking approach. In time we expect proactive systemic management to change the way finance is done.

From now on this city will manage its past and future financing proactively and systemically, based on the MSP 1423, with full access, transparency, and active involvement for providers. We will include in that management every factor that significantly influences the city's return from that financing—the development initiatives that it funds and resulting performance gains. We will include every factor that might threaten the city's ability to sustain the needed returns on and returns of capital to finance providers, monitoring and controlling our own policies and decisions to protect providers. Proactive systemic management of the whole finance cycle, including our development program, will make this city a much larger consumer of finance and produce attractive returns at unusually low levels of risk.

Step 4 of the Method: MSAA and MSP Setup and Initial Analyses.

Finance providers agree to participate with the city in the next major step, setting up the Metropolitan Sustainability Assurance Agent (MSAA 1428) and the definitive Metropolitan Steering Platform (MSP 1423). The MSAA 1428 is incorporated with the city as the founding shareholder and with equity shares available for city suppliers, finance providers, and other interested organizations. MSAA 1428 staff include experts in dynamic simulation and analysis, project and program management, finance, audit, and IT. The MSAA 1428 immediately begins the process of designing, setting up, and validating the MSP 1423 and preparing for dynamic analysis of metropolitan performance, development options, and financing (1622).

The first dynamic analyses are of the city's past performance, conducted to build understanding of how non-systemic management of metropolitan feedback structures has made the city unsustainable. Subsequent analyses are of development-program options (individually and in combinations) and of development, economic, and city-management risks (individually and in combinations). Results of these analyses enable the city and its stakeholders to start focusing on the most attractive and potent options for enhancing metropolitan performance and mitigating key risk factors. Dynamic performance optimization is the main vehicle, using the MSP 1423 to search automatically across huge numbers of option combinations that will robustly provide substantial performance gains in the face of key risks.

It is during this stage that city stakeholders begin to engage in the process of testing metropolitan development and management options. The number and diversity of involved stakeholders grow rapidly, and the analysis process benefits from the integration of their various knowledges. The transparency, easy accessibility, and analytical power of the MSP 1423 quickly make it popular with a wide range of stakeholder types. They find that many formerly intractable differences of opinion regarding city management and financing tend to diminish or even disappear in the face of proactive systemic analysis made possible by the MSP 1423. They attribute that to the comprehensive, integrated views offered by the MSP 1423 and to the capability it provides for rapid collaborative design and testing of city initiatives.

In just under two years, the city and its stakeholders have defined a development program and related funding which will (as demonstrated by the dynamic analyses) put the city on a different performance trajectory leading to sustainability (1624). Detailed program design goes on for another year, working out the sequence, pacing, and resourcing of component projects that will deliver synergistic benefits with a minimum of operational disruption for the city and its inhabitants. Bidding and contracting for the initial batch of projects moves forward in parallel, utilizing the expertise of and information from potential suppliers.

Step 5 of the Method: Full Implementation of Proactive Systemic Management.

By the time development contracts are beginning to be let, the city and the MSAA 1428 have prepared to conduct proactive systemic management work, based on the MSP 1423, on all three critical fronts: the city development program and its component projects; overall metropolitan performance; and the finance cycle (1626).

This example has focused on the Method as applied to city government as the subject institution. Application of the Method will be broadly similar in other types of institutions, but with specific differences relating to the nature of those institutions and their situations. A commercial corporation, for example, having direct competitors, will likely be more selective about involving stakeholders in the process of proactive systemic management and take greater precautions for protecting confidential information.

As desired, the system may include more or fewer than the components illustrated.

The system is described above with reference to block and flow diagrams of systems, methods, apparatuses, and/or computer program products according to examples. In some instances, the publisher and reader users may access the system by desktop or laptop computers. In some embodiments, the publisher and reader users may access the system by mobile devices such as smart phones. In some embodiments, the publisher and reader users may access the system by tablet computers or any commercial computing device connected to the internet. In some cases, the system may be constructed to operate on the internet independent of existing systems. The significant event system may operate using existing social networks, e.g., Facebook®, Google+®, or Yammer™ as platforms using existing application interfaces open to website developers.

One or more blocks of the block diagrams and flow diagrams, and combinations of blocks in the block diagrams and flow diagrams, respectively, can be implemented by computer-executable program instructions. Some blocks of the block diagrams and flow diagrams may not necessarily need to be performed in the order presented, or may not necessarily need to be performed at all, in some cases.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the system has been described in connection with certain examples, is the system is not limited to the disclosed embodiments, but on the contrary, includes various modifications and equivalent arrangements. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or communication data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Other implementations are also within the scope of the following claims.

1. A computer-implemented method comprising
generating, by a computer operating a calibrated and tested dynamic simulation model of at least one municipality or institution or commercial entity, first information indicative of future performance or sustainability of the municipality or institution or commercial entity according to received information indicative of one or more development projects or ongoing operations or policies of the municipality or institution or commercial entity, the first information being generated based on one or more values associated with each of one or more stocks or one or more flows associated with the municipality or institution or commercial entity;
monitoring, by a computer operating the dynamic simulation model, a time evolution of values associated with each of one or more of the stocks or one or more of the flows during execution of one or more of the development projects or during the ongoing operations or policies of the municipality or institution or commercial entity;
determining, by a computer operating the dynamic simulation model, a projection associated with future finances of the municipality or institution or commercial entity based on the first information indicative of future performance or sustainability and the time evolution of the values, and
providing second information indicative of the projection associated with future finances to one or more actual or potential financers of the development projects or to a representative of the municipality or institution or commercial entity.

2. The method of claim 1 in which the simulation model spans two or more development projects of the municipality or institution or commercial entity.

3. The method of claim 2 in which the two or more development projects are synergistic relative to the performance or sustainability of the municipality or institution or commercial entity.

4. The method of claim 1 in which the dynamic simulation model has been tested using historical data representing operations or policies of the municipality or institution or commercial entity.

5. The method of claim 1 in which products of suppliers of one or more of the development projects have characteristics that are particularly applicable to the one or more of the development projects of the municipality or institution or commercial entity based on the information generated by the simulation model.

6. The method of claim 1 in which the municipality or institution or commercial entity and suppliers of products for one or more of the development projects both have access to operation of the dynamic simulation model.

7. The method of claim 6 in which other stakeholders have access to operation of the dynamic simulation model.

8. The method of claim 1 in which the financers have access to operation of the dynamic simulation model.

9. The method of claim 1 in which the second information is provided to the financers of the development projects prior to their financing one or more of the development projects.

10. The method of claim 1 in which the second information is provided to the financers of the development projects after they have financed one or more of the development projects, during the period when one or more of the projects are being executed and operated.

11. The method of claim 1 in which the municipality or institution or commercial entity comprises a city.

12. The method of claim 1 in which the municipality or institution or commercial entity comprises contiguous cities and towns.

13. (canceled)

14. The method of claim 1 in which the development projects comprise infrastructure projects.

15. The method of claim 1 in which the dynamic simulation model is operated by at least one of: (a) the municipality or institution or commercial entity, (b) a supplier of products for one or more of the development projects, (c) at least one of the financers, or (d) a party other than the municipality or institution or commercial entity, the suppliers, or the financers.

16. (canceled)

17. (canceled)

18. (canceled)

19. A computer implemented method comprising
generating, by a computer operating a calibrated and tested dynamic simulation model of a municipality or institution or commercial entity on behalf of a supplier, first information indicative of future performance or sustainability of the municipality or institution or commercial entity that is sufficient to inform the design, by the supplier, of products for development projects that will enhance the performance or sustainability of the municipality or institution or commercial entity, the first information being generated based on one or more values associated with each of one or more stocks or one or more flows associated with the municipality or institution or commercial entity;
based on the first information and based on the design of the products for the development projects, generating, by a computer operating the dynamic simulation model, second information demonstrating the effect of the design of the products on the values associated with each of at least some of the stocks or at least some of the flows and on the performance or sustainability of the municipality or institution or commercial entity; and
displaying, on a user interface, at least some of the first information, at least some of the second information, or both, according to instructions received from the supplier.

20. The method of claim 19 in which the dynamic simulation model comprises a model also used by the municipality or institution or commercial entity.

21. The method of claim 19 in which the dynamic simulation model comprises a model also used by financers of development projects for the municipality or institution or commercial entity.

22. The method of claim 19 in which the supplier comprises a supplier of physical facilities or equipment, or services.

23. The method of claim 19 in which the supplier comprises a supplier of services.

24. The method of claim 19 in which the municipality or institution or commercial entity comprises a city.

25. The method of claim 19 in which the development projects comprise infrastructure projects.

26. (canceled)

27. A computer implemented method comprising
generating, by a computer operating a calibrated and tested dynamic simulation model of a municipality or institution or commercial entity on behalf of one or more financers of development projects or operations or policies of the municipality or institution or commercial entity, first information generated based on one or more values associated with each of one or more stocks or one or more flows associated with the municipality or institution or commercial entity, the first information indicative of predicted future values associated with at least some of the stocks or at least some of the flows associated with the municipality or institution or commercial entity, the future values resulting from a relationship between (i) proposed development projects or operations or policies and (ii) performance or sustainability of the municipality or institution or commercial entity;
providing, through a user interface, at least some of the first information and second information about products to be supplied to the municipality or institution or commercial entity to implement a development project or operation; and
wherein the first information, the second information, or both, is sufficient to inform the establishment, by one or more of the financers, of proposed terms under which the financers will finance the products to be supplied to the municipality or institution or commercial entity.

28. The method of claim 27 in which the dynamic simulation model comprises a model also used by the municipality or institution or commercial entity.

29. The method of claim 27 in which the dynamic simulation model comprises a model also used by suppliers of the products.

30. The method of claim 27 in which the municipality or institution or commercial entity comprises a city.

31. The method of claim 27 in which the municipality or institution or commercial entity comprises a city or contiguous cities or towns.

32. The method of claim 27 in which the development project comprises an infrastructure project.

33. The method of claim 27 in which the products comprise physical facilities or equipment, or services.

34. The method of claim 27 in which the financers are enabled to determine risks and rewards of the development project based on operation of the dynamic simulation model.

35. The method of claim 27 in which the proposed terms include a type of investment vehicle and a level of return on the investment.

36. A computer-implemented method comprising
generating, by a computer operating a calibrated and tested dynamic simulation model of a municipality or institution or commercial entity on behalf of the municipality or institution or commercial entity, first information indicative of future performance or sustainability of the municipality or institution or commercial entity, including calculating predicted future values associated with each of one or more stocks or one or more flows associated with the municipality or institution or commercial entity; and
displaying, on a user interface, at least some of the first information to suppliers of products associated with the development projects or operations and policies and to financers of the products or development projects.

37. The method of claim 36 in which the dynamic simulation model is operated by the municipality or institution or commercial entity.

38. The method of claim 36 in which the dynamic simulation model is operated by a party other than the municipality or institution or commercial entity, on behalf of the municipality or institution or commercial entity.

39. The method of claim 36 in which the dynamic simulation model spans all of the development projects of the municipality or institution or commercial entity.

40. The method of claim 36 in which the dynamic simulation model spans all operating activities and major policies of the municipality or institution or commercial entity

41. The method of claim 36 in which the dynamic simulation model is tested using historical data about the operation of the municipality or institution or commercial entity.

42-51. (canceled)

52. The method of claim 1, in which the value of a particular stock is based on a past or present value of one or more other stocks, one or more flows, or both.

53. The method of claim 1, in which one or more values associated with each of one or more stocks or one or more flows includes calculating the values using one or more equations that are included in a representation of the municipality or institution or commercial entity that is used by the dynamic simulation model.

54. The method of claim 53, comprising using values indicative of past performance of the municipality or institution or commercial entity as inputs to the one or more equations.

55. The method of claim 1, in which determining one or more values associated with each of one or more stocks or one or more flows includes determining an evolution over time of at least one of the values.

56. The method of claim 55, comprising displaying information indicative of the time evolution of the value.

57. The method of claim 1, comprising monitoring a change over time in relative importance of each of two or more stocks.

58. The method of claim 1, comprising identifying at least one high leverage stock associated with the municipality or institution or commercial entity to which the performance of the municipality or institution or commercial entity is particularly sensitive.

59. The method of claim 58, in which the generated information is based on a value of the high leverage stock.

60. The method of claim 1, comprising calibrating the dynamic simulation model.

61. The method of claim 60, in which calibrating the dynamic simulation model comprises:
using the dynamic simulation model to simulate a past performance of the municipality or institution or commercial entity; and
comparing results of the simulation of the past performance to historical performance data for the municipality or institution or commercial entity.

62. The method of claim 61, comprising based on results of the comparison, adjusting a representation of the municipality or institution or commercial entity that is used by the dynamic simulation model.

63. The method of claim 62, in which the representation that is used by the dynamic simulation model includes one or more equations indicative of feedback mechanisms among one or more stocks or one or more flows or both.

64. The method of claim 63, in which adjusting the representing includes adjusting one or more of the equations, adjusting a numerical quantity associated with one or more of the equations, or both.

65. The method of claim 1, in which generating the first information indicative of future performance or sustainability is based on uncertain input data.

66. The method of claim 1, in which the first information is indicative of one or more development projects that will alter the operational performance trajectory or financial performance trajectory or both of the municipality or institution or commercial entity in a sustainable manner.

67. The method of claim 1, in which generating the first information includes generating information sufficient to evaluate the suitability of suppliers and products based on their long-term influence on the performance of one or more development projects.

68. The method of claim 1, comprising determining, using the dynamic simulation model, data indicative of the actual implementation and performance of one or more of the development projects that can be used to influence the time evolution of the values.

69. The method of claim 68, in which the data are indicative of a cost or a schedule or both associated with one or more of the development projects.

70. The method of claim 1, in which the scenario-based projection associated with future finances includes a predicted return of investment capital, a predicted return of investment capital, or both.

71. The method of claim 1, in which the second information is information indicative of financial sustainability of the municipality or institution or commercial entity.

72. The method of claim 1, comprising receiving input indicative of a change to a development project or an ongoing operation or policy; and generating information indicative of future performance or sustainability based on the received input.
